(19) United States
(12) Patent Application Publication
(10) Pub. No.: US 2017/0249284 A1
(43) Pub. Date: Aug. 31, 2017

(54) Equation Engine

(71) Applicant: Jesse Clement Bunch, Silver Spring, MD (US)

(72) Inventor: Jesse Clement Bunch, Silver Spring, MD (US)

(21) Appl. No.: 15/369,865

(22) Filed: Dec. 5, 2016

Related U.S. Application Data
(60) Provisional application No. 62/262,392, filed on Dec. 3, 2015.

(51) Int. Cl. G06F 17/11; G09B 5/02; G09B 19/02; G06F 3/0482; G06F 7/523

(52) U.S. Cl. CPC G06F 17/11; G06F 3/0482; G06F 7/523; G09B 19/025; G09B 5/02

(57) ABSTRACT

This invention, the Equation Engine assists users to solve problems using equations. The Equation Engine helps users to select an equation from a local or remote database of equations, to collect values and units for the variables, and to solve for the unknown. The Equation Engine provides means for the user to solve problems by equating two equations. The Equation Engine provides means for a user to easily combine equations using equators. The Equation Engine provides one-button access to a tool for quickly solving the Quadratic Formula. The Equation Engine provides one-button access to a tool for quickly computing the mass for chemical species.

### CROSS REFERENCE TO RELATED APPLICATIONS

This application claims priority to U.S. Provisional Application No. 62/262,392, filed Dec. 3, 2015, by Jesse Clement Bunch, entitled “Equation Engine”, the disclosures in which are incorporated herein in their entireties by this reference.

### FIELD OF THE INVENTION

This invention relates to the more effective use of equations in computer-based systems to solve problems. These improvements will benefit students and others who use equations on computer-based devices and/or systems. Herein, the term “equation” refers to any equation (including, but not limited to, any chemical equation), inequality, expression, equator, lessor, greator, or any similar construct or any combination thereof or any other means for relating variables and/or constants—each in this list being with or without units.

Equation Engine embodiments can be implemented on a broad range of devices and/or environments. For example, the Equation Engine can reside on dedicated device like a calculator. The Equation Engine can be implemented on local computer-based and/or cloud-based applications. The Equation Engine (EE) can be implemented as an app various browsers. The EE can be located locally and/or remotely. The EE can be implemented as a plug-in or add-on and can implemented to pop-up in the operating system and/or in any other application. The equations can reside in the app and/or in a local storage device and/or on a remote storage device (such as the internet and/or the cloud).

### BACKGROUND

The application of equations is important in virtually every discipline, including business and economics. For example, the practice of STEM (science, technology, engineering and math) typically involves the application of equations. Perhaps the central activity in many STEM courses is the solution of problems using equations. Given the equation, calculators, such as the TI-83+ and TI-84+, have simplified the calculation process. Word processing software, such as Microsoft Word, and typesetting software products, like as those based on TeX (such as LaTeX) provide the capacity to display complex equations. A very sophisticated package for manipulating equations, the Euler Math Toolbox (EMT), provides means for entering, displaying, solving, and graphing complex equations. The MathIsFun.com website provides a list of equations that one can fill in and solve and a separate means to enter and graph an equation. WolframAlpha provides numerous tools for selecting equations by topic and solving them. WolframAlpha allows a user to enter a formula or a part of a formula and it will often anticipate the rest of the formula. WolframAlpha supports entering a partial list of values with units and determines the relevant equation and solves for the unknown. WolframAlpha does not display a version of the equation solved for the unknown. WolframAlpha does not display said version solved for the unknown with the values replacing the variables.

### SUMMARY

Much of the learning process in STEM at this time involves determining which equation (or equations) to use and how to use it. The instant invention helps to automate and simplify that process. The instant invention, herein referred to as the “Equation Engine” provides means and methods for a user or users to select an equation. Herein, “to select” refers to: to perform a search for an equation and/or to enter an equation and/or to provide an equation for present and/or future use. Multiple modes for searching for an equation are disclosed herein. Multiple modes for entering an equation are disclosed herein. Multiple modes for providing an equation are disclosed herein. When a user has selected one or more equations, he has determined that said equation(s) are relevant for his needs. Preferred embodiments of the Equation Engine provide the user a means to easily perform one or more of the following tasks (often, but not necessarily, in the following order):
select and display the relevant equation(s) in its standard form
determine the units and values for each variable, the value of one will be “?”
rewrite the symbolic equation for the unknown to be solved
plug the user-given values for the other variables and constants into the equation and optionally display the result
solve and display the value for the unknown on a computer-based system.

In some embodiments all of these steps will be displayed. In others, some of these steps do not need to be displayed.

Some of the steps described above can be combined. For example, some embodiments of this invention provide a space (such as an object of type UITextView in iOS or OS X) wherein the user can enter a set of values with their units. When one equation uniquely relates those variables, the Equation Engine can automatically and without user input select said equation, solve said equation for the unknown, plug the specified values into said equation, solve said equation for said unknown and display the results of one or more of those steps. When more than one equation can relate those values, both can be solved in parallel and/or the Equation Engine can display the relevant options of equations to the user who can choose which to use. Herein, “TextView” or “UITextView” can refer to “TextField” or “UITextField” when the field is user editable, “TextField” or “UITextField” can refer to “TextView” or “UITextView” when the field is user editable, and “TextField” or “UITextField”, “TextView”, or “UITextView” can refer to “Label” or “UILabel” when the field is not user-editable.

Alternatively, each of said values and its units can be entered, for example, via a horizontal linear array of fields (where each field can be an object of type UITextField in iOS or OS X). For each variable, the user can have the choice of entering the values' units, the symbol (for example “P” for pressure) for the extent of the variable or the extent represented by those units. The U.S. National Institute of Science and Technology uses the term “quantity” for the property measured by the units. As this term is confusing to users, herein the term “extent” is used. For example, the extent called “pressure” is typically measured in, kPa, atmospheres, or torr. In many math equations, generic units are used. For example, in “A=πr²”, the default units are just called “units” even though they technically are generic units of extent “length”. The units for “A” then are generic units of extent “square units” or “area” often called “units squared” or “units²”. For some equations, units are not relevant. In the EE “extent” is a very broad concept that is not limited to physical quantities, but rather comprises any quantifiable property, such as, value, cost, SAT score of a person, average SAT scores for a school, a part or list of parts for a device, etc.

This process greatly expedites and simplifies what constitutes most of the homework and learning in STEM classes and greatly expedites and simplifies the process for STEM practitioners. Using this invention will also reduce incorrect answers resulting from the common practice of incorrectly plugging values into a scientific calculator. Other embodiments might contain a subset of these capabilities.

Along with potential relevant equation(s), EE can display additional information on the equation (via embedded information, hyperlinked information, or available via ETS Views), its variables, its constants, the operators it uses, its applications and/or, the relevant subject matter. This additional information comprises one or more of:
a verbal description of one or more of these;
graphics providing a better understanding of one or more of these, including the ability to produce graphs;
videos providing a better understanding of one or more of these;
lectures providing a better understanding of one or more of these;
examples of problems that use one or more of these, worked out with text, pictures, graphics and/or videos;
references to related equations, variables, and/or operators for each of these;
derivation(s) of one or more of these;
values of related constants that are often hard to find and/or absent from a textbook or even online, such as the heats of formation of a wide range of compounds;
homework problems (with or without the solutions) to help teach and/or evaluate the understanding of these, potentially comprising the automated grading of said homework.

Likewise, the Equation Engine can provide the same information for variables, constants and/or operators, independent of a given equation.

For further elaboration about this additional information, please see Extended Information in the Views Provisional and Utility Patent applications, by the inventor of this application.

Regarding the homework problems, one (or more) teachers (and/or other stakeholders, such as: schools, school systems, potential employers, etc. . . . see the above-referenced Views Patent Applications) can assign problems presented in the Equation Engine. These problems may be a subset of problems provided by the Equation Engine or by one or more stakeholders. Likewise, the Equation Engine can provide the student (or the appropriate learning and/or testing authority) control over options in the Equation Engine for a subset of the users of the Equation Engine for a specific time and/or duration and/or from the start of some set of conditions until a given set of conditions is met. Such options might include options for certain problems, assignments, and/or during testing.

### The Emerald Tablet Method

As illustrated below, the Equation Engine supports the implementation of the Emerald Tablet Method for solving problems that involve equations, by displaying the steps and assisting the user with the steps of the Method. The Emerald Tablet Method reduces errors and expedites the solution of problems. Implementing it on a computer-based system greatly expedites the use of the Method and can provide numerous other benefits to the process. For example, being computer-based the Equation Engine can provide access to an extensive collection of values of constants that can be used in solving problems, i.e. the heat capacities of a large number of materials.

Each equation is typically known by a “standard form”. Said standard form is said equation written with a standard set of symbols, each symbol referring to one of the variables or constant(s) in said equation, said symbols being written in a predefined order. For example, the standard form for the equation for the Ideal Gas Law is “PV nRT”, where “P” is the symbol used to represent the pressure of a given sample of gas, “V” is the symbol used to represent the volume of said sample of gas, “n” is the symbol used to represent the number of moles in said sample of gas, “R” is the gas constant (the value of which depends upon the units of the other variables), and “I” is the symbol used to represent the temperature of said sample of gas and typically is used in Kelvin units.

Often when solving problems, the value(s) for each variable is known, except one. In this case, the equation can first be solved for the unknown variable using the original symbols, using methods commonly known. For example, if the values for each variable in the Ideal Gas Law are known, except for the temperature, the equation can be rewritten in the form “T=PV/(nR)”.

Preferred Steps of the Emerald Tablet Method:

1. Select and display the appropriate equation(s). After the user-assisted selection process (more detail below), the Equation Engine displays the equation in its standard form, e.g.:

P·V=n·R·T or PV=nRT

2. Determine the units of each variable and the values for each variable, except for one, referred to as “the unknown”. The standard units are displayed. The user can enter values in other units. The unknown can be a constant, as a student might be asked to determine compute the value of said constant.

3. Solve the equation in symbolic form for the unknown and display the equation in that form.

4. Substitute the known variables and the constants and display that.

5. Solve and display the value of the unknown and its units, said units being the standard units for this equation. If the user selects units other than the standard units for said unknown, then the solution will be computed and displayed in said user-selected units and perhaps also in the standard units.

The Equation Engine displays the variables and constants, their units and a space for the user to enter the value and units if other than standard. The values may be already in place, depending upon the method the user employed to select the equation.
a. P=______ kPa
b. V=______ L
c. n=______ moles
d. R=8.314 kPa·L·moles⁻¹·K
e. T=______K

The user enters the values and can alter the units, if other than standard.
a. P=327 kPa
b. V=43.6 L
c. n=? moles
d. R=8.314 kPa·L·moles⁻¹·K
e. T=325K

The “?” (or another means) can designate that the number of moles is the unknown. The user can enter this or the Equation Engine can deduce that this is the unknown as all of the other values are known.

Display the equation rewritten as solved for the unknown.

The Equation Engine solves for the unknown and displays the rewritten equation

$$n = \frac{P \cdot V}{R \cdot T}$$

Display the equation with the known values replacing the variables (and, their units) in the rewritten equation.

The Equation Engine displays the equation with the known values replacing the variables in the rewritten equation.

$$n = \frac{327 \cdot 43.6}{8.314 \cdot 325}$$

Calculate and display the answer with the proper units.

The Equation Engine calculates and displays the answer with the proper units.

n=5.28 moles

In the preferred embodiment, users can chose to perform more steps themselves as students perfect the process or professionals. The order of steps 1 and 2 may vary.

### Equation Selection

Currently, students can take the time to compile relevant equations, but this usually not done until the test. Sometimes teachers provide lists of equations. It can still be difficult and/or time-consuming to determine which equation to use to solve a given problem. The instant invention makes that process much easier.

Preferred embodiments of this invention provide numerous methods for a user to select the relevant equation. In one method, the user scrolls through a list of equations. The list can contain all equations supported by the instantiation of the invention or just all equations relevant to a given discipline, e.g. Physics, Chemistry, Biology, Mechanical and other forms of Engineering, Geometry, Calculus, etc. or all equations relevant to a given course at a given academic institution (school system, school, university, etc.) or all equations relevant to a given topic, e.g. electrical conductivity. By observing the equations that a user is using, the invention can determine what course a student is taking and thereby anticipate the equations that the student will next be using.

When the user enters the space in the preferred embodiment where equation selection can occur, the last equation used and the values for its variables can populate the user's variable input fields. Likewise, the preferred embodiment can keep a log of the equations most recently and/or most often used and the values of their variables. The user can, for example, scroll through this log. The invention can provide means for the user to define the size of the log and can clear all or parts of it

Another method for the user to select an equation is to enter the equation's name (e.g. “Ideal Gas Law”) or the equation itself, e.g. PV=nRT or a variant of that equation, e.g. T=PV/(nR).

The user can enter a topic or descriptor for all equations related to, for example, “chords of circles”.

When an equation has at least some of variables with units, the user can select an equation by entering the units of those variables (without their values) or the symbols or names for the properties represented in the desired equation or any combination thereof. If, for example, the user forgets the name “Ideal Gas Law” and its equation, he can enter the units and/or properties posed in the problem. For example, “How many moles of hydrogen in a 43.6 liter container at a pressure of 327 kPa at 325K?” The user can enter:
“L kPa K” which represents the symbols for the units of the variables in the equation, or
“moles, liters, kPascals, Kelvin” which represent the names of the units of the variables in the equation, or
“n, V, P, T” which represent the symbols for the properties represented in the equation, or
“number, volume, pressure, temperature” which represent the names of the properties represented in the equation, or
one or more symbols or names of constants, e.g. “R” or “the gas constant”, or
any combination of names and/or symbols of units and/or properties is not important may be mixed in the user input, e.g. “moles, L, pressure K”.

In the preferred embodiments, extraneous names and/or symbols of units and/or properties might introduce extra equations to choose from, but might not eliminate equations from the list.

The user can enter values and units that are not standard and the Equation Engine will convert them to the standard unit. This is handled by a Units Conversion Engine. A unique property of the Units Conversion Engine is that it provides the Equation Selection algorithm, the properties represented by those units. One way that the Equation Selection algorithm uses to select equations is by the configuration of properties that the user selects.

Entering the symbols for the units of the variables is recommended because it is the most concise and precise. Constants, such as “R” in this example, can be entered, but it is not necessary. The order of entry of names and/or symbols of units and/or properties is not important. As the list of names and/or symbols of units and/or properties is entered, the invention can create a list of equations that meet the requirements of the input string. As the list of names and/or symbols of units and/or properties and/or constants grows, the list of equations that meet the requirements of the input string shrinks, until one equation remains or there are few enough for the user to select the appropriate one.

### Entry of Values

When an equation is selected, the invention displays a field for each variable and constant in the equation. The user can enter and/or edit the value and/or units of each variable for this problem. The value of a field can be designated as an unknown by leaving it blank or, for example, entering a “?”. The equation selection and entry of values can be expedited by combining these two steps. In this case, the user, for example, enters the values with their units at the same time, e.g. “? moles, 43.61 L, 327 kPa, 325K”. This string uniquely defines the ideal Gas Law and the values needed to solve for the number of moles of gas. If the user enters “?” to replace the value for the constant and provides values for all of the variables, the Equation Engine will recalculate a value for the constant. This can be an interesting exercise for students. That value will not, under normal circumstances, replace the Equation Engine's value for the constant. User input in the preferred iOS or OS X version is via an editable TextView.

The preferred embodiments will accept units that are not standard for the equation and convert them to the units that are standard for the equation. For example, in the previous example, the user can enter “? moles, 43.6 L, 327 kPa, 52 C”. The preferred embodiments of the Equation. Engine will recognize that “52 C” is a temperature (52 Celsius) and convert that to “327 K”.

The preferred embodiments of the Equation Engine will, in some cases, return a “cluster” of equations. For example, it is typically useful when displaying the equation for traveling waves, to also display and permit input into the equations for its components.

### Multi-State Equations

Some problems relate to a system in different states at different times or compare two or more different systems of the same type. These typically employ a type of equation, herein referred to as a “multi-state” equation. An example is the two-state version of the Ideal Gas Law: P₁V₁/(n₁T₁=P₂V₂/(n₂T₂). Preferred embodiments of the Equation Engine will support multi-state equations. Besides helping users to solve such problems, this will provide users greater familiarity with and insight into multi-state equations and encourage more use of such with two or more states.

Multi-state equations can be derived from any one-state equation by setting the equator (described elsewhere herein) for one state equal to the Equator for the second state and cancelling any constants. Using the Ideal Gas Law example, the equator for the Ideal Gas Law is:

$$\frac{PV =}{nRT}$$

Setting the Equators equal yields:

$$\frac{{P}_{1} \cdot {V}_{1}}{{n}_{1} \cdot R \cdot {T}_{1}} = \frac{{P}_{2} \cdot {V}_{2}}{{n}_{2} \cdot R \cdot {T}_{2}}$$

Cancelling the constant yields:

$$\frac{{P}_{1} \cdot {V}_{1}}{{n}_{1} \cdot {T}_{1}} = \frac{{P}_{2} \cdot {V}_{2}}{{n}_{2} \cdot {T}_{2}}$$

If, for example, the unknown is V₂, the Equation Engine can display the equation as solved for V₂:

$${V}_{2} = \frac{{P}_{1}}{{P}_{2}} \cdot \frac{{n}_{2}}{{n}_{1}} \cdot \frac{{T}_{2}}{{T}_{1}} \cdot {V}_{1}$$

This notation simplifies the understanding of the solution of multi-state problems, especially when the values are given as ratios. An example would be: “In a sample of gas, the pressure is tripled, the number of moles is decreased by 64%, and the temperature is increased by 60.%. How is the new volume related to the original volume?”

The Equation Engine performs and displays the following steps:

$${V}_{2} = \frac{{P}_{1}}{3.0 {P}_{1}} \cdot \frac{( 1 - .64 ) {n}_{1}}{{n}_{1}} \cdot \frac{( 1 + .60 ) {T}_{1}}{{T}_{1}} \cdot {V}_{1}$$

$${V}_{2} = \frac{1}{3.0} \cdot \frac{.36}{1} \cdot \frac{1.60}{1} \cdot {V}_{1}$$

$${V}_{2} = .19 {V}_{1}$$

Depending upon the settings, the user may be required, to perform one or more of the steps.

Likewise, any number of states can be equated:

$$\frac{{P}_{1} \cdot {V}_{1}}{{n}_{1} \cdot {T}_{1}} = \frac{{P}_{2} \cdot {V}_{2}}{{n}_{2} \cdot {T}_{2}} = \frac{{P}_{3} \cdot {V}_{3}}{{n}_{3} \cdot {T}_{3}} = … = \frac{{P}_{i} \cdot {V}_{i}}{{n}_{i} \cdot {T}_{i}}$$

In a preferred embodiment for iOS or OS X (for example), when the user begins entering values and/or units in a first iOS or OS X editable TextView for the first state of the system (labeled “state 1”, for example), a second iOS or OS X editable TextView is created next to the first editable TextView allowing for the input of data for a second state of the system (labeled “state 2”, for example). If the user does not enter input into this second TextView and does not otherwise communicate that there is a second state, the Equation Engine will assume that the problem is a single-state problem. Likewise in this preferred embodiment, when the user begins entering values and/or units in a second editable TextView for the second state of the system, the variable symbols for both states will be given the subscript of their state number. Also, when data is entered for a second state, a third editable TextView is created allowing for the input of data for a third state of the system (“state 3”, for example) and the variable symbols will be appropriately subscripted. If the user does not enter input into this third TextView and does not otherwise communicate that there is a third state, the Equation Engine will assume that the problem is a two-state problem. In general, every time the user communicates that there is an additional state in the problem by entering data into its TextView, the Equation Engine generates an additional TextView for the input of data for an additional state.

Like the problem above, often the cases represent the state of a given system at different times. For example, “4.62 L water is electrolyzed into hydrogen and oxygen. What temperature must the mixture of gases be such that the velocity of the oxygen molecules is the same as the velocityᵣₘₛ of the hydrogen molecules at 347K?” Note that amount of water electrolyzed is irrelevant to the solution of this problem. Other problems can include the same base equation, but different objects.

The form of a comparator (an equator, a greator, or a lessor) designates how it should be written as an equation. For example,

$$\frac{V = P}{nRT}$$

is an equator that translates to

$$V = \frac{nRT}{P} and \frac{VP}{nR = T}$$

is an equator that translates to

$$\frac{VP}{T} = nR .$$

Being an equator, the product of the terms in the numerator equals the product of the terms in the denominator, independent of the location of the equal sign. The location of the “=” is used to translate the equator back to an equation defining which variables are on the left side of the equation and which are on the right. If the “=” is in the numerator, everything to its left goes on the left side of the equation. If the “=” is in the denominator, everything to its left goes on the right side of the equation.

### Multi-Equation Problems

Many problems do not involve a single equation, such as “What is the velocity of a 579 kg satellite in orbit at 173 miles above the earth?” The primary part of solving this multi-equation problem is to recognize that a satellite in orbit represents the situation where the force of gravity between the earth and the satellite is equal to the centripetal force necessary to keep the satellite in the given orbit. So the user can, for example, enter “force”. The Equation Engine responds by listing equations with the variable “force”, (for illustration, not meant to be comprehensive):

$$\begin{matrix}E 0 \text{:} F = m \cdot a & mass \times acceleration \\ E 1 \text{:} F = \frac{Δ P}{Δt} & momentum \text{/} time \\ E 2 \text{:} F = m \cdot g & gravity ( near the Earth ' s surface ) \\ E 3 \text{:} F = \frac{G \cdot {m}_{1} \cdot {m}_{2}}{{r}^{2}} & gravity ( general ) \\ E 4 \text{:} F = {μ}_{s} \cdot {F}_{n} & friction ( static ) \\ E 5 \text{:} F = {μ}_{k} \cdot {F}_{n} & friction ( kinetic ) \\ E 6 \text{:} F = \frac{m \cdot {v}^{2}}{R} & centripetal \\ E 7 \text{:} F = \frac{k \cdot {q}_{1} \cdot {q}_{2}}{{r}^{2}} & Coulomb , electrostatic \\ E 8 \text{:} F = E \cdot q & electric field \times charge \\ E 9 \text{:} F = P \cdot A & pressure \times area \end{matrix}$$

The user can then select the two force equations to use. In this case, the user can enter: E3=E6

In response, the Equation Engine displays:

$$\frac{G \cdot {m}_{1} \cdot {m}_{2}}{{r}^{2}} = \frac{m \cdot {v}^{2}}{R}$$

$$E 3 \text{:} F = \frac{G \cdot {m}_{1} \cdot {m}_{2}}{{r}^{2}}$$

$$G = 6.673848080 E \text{-} 11 N {m}^{2} \text{/} {kg}^{2}$$

$${m}_{1} = \underline{ } kg$$

$${m}_{2} = \underline{ } kg$$

$$r = \underline{ } m$$

$$E 6 \text{:} F = \frac{m \cdot {v}^{2}}{R}$$

$$m = \underline{ } kg$$

$$v = \underline{ } m {s}^{- 1}$$

$$R = \underline{ } m$$

The user enters what is known about the problem:

$$\frac{G \cdot {m}_{1} \cdot {m}_{2}}{{r}^{2}} = \frac{m \cdot {v}^{2}}{R}$$

$$E 3 \text{:} F = \frac{G \cdot {m}_{1} \cdot {m}_{2}}{{r}^{2}}$$

$$G = 6.673848080 E \text{-} 11 N {m}^{2} \text{/} {kg}^{2}$$

$${m}_{1} = mass of earth$$

$${m}_{2} = 579 kg$$

$$r = radius of earth + 173 miles$$

$$E 6 \text{:} F = \frac{m \cdot {v}^{2}}{R}$$

$$m = {m}_{2} = 579 kg$$

$$v = ? \\ R = r$$

$$\frac{G \cdot {m}_{1} \cdot {m}_{2}}{{r}^{2}} = \frac{m \cdot {v}^{2}}{R}$$

The Equation Engine recognizes “mass of earth”, “radius of earth”, “r” and expands them as shown below, then solves the equation for “v”, shows that equation with the values of the variables and constants, then provides the final answer;

$$E 3 \text{:} F = \frac{G \cdot {m}_{1} \cdot {m}_{2}}{{r}^{2}}$$

$$G = 6.673848080 E \text{-} 11 N {m}^{2} \text{/} {kg}^{2}$$

$${m}_{1} = mass of earth = {m}_{e} = 5.97219 E 24 kg$$

$${m}_{2} = 579 kg$$

$$r = {R}_{e} + 173 miles = 6.371 E 6 m + 173 miles * 1.61 E 3 m \text{/} mile = 6.95 E 6 m$$

$$E 6 \text{:} F = \frac{m \cdot {v}^{2}}{R}$$

$$m = {m}_{2} = 579 kg$$

$$v = ? \\ R = r = 6.95 E 6 m$$

$$v = \sqrt{\frac{G \cdot {m}_{e}}{r}} = \sqrt{\frac{6.673848080 E \text{-} 11 \cdot 5.97219 E 24}{6.95 E 6}} = 7.57 E 3 m \text{/} s$$

Preferred embodiments will also support multi-state, multi-equations. Preferred embodiments will support the solution of multi-equation problems, including multi-state multi-equation problems, via the input of variable names and/or symbols as described above for single equation problems.

### Miscellaneous Supported

Herein “support” refers to the ability to input in a supported form, the ability to process in that supported form and the ability to display or otherwise output in that supported form. Preferred embodiments will also support data types comprising: logical, whole numbers, natural numbers, integer numbers, real numbers, complex numbers, Hamiltonian (Quaternion and Octonian) data types. All common notations will be supported including decimal and scientific notation. Variables and constants can be scalars, vectors, arrays and/or matrices of these types, tensors, and user-defined types with and without units. Preferred embodiments will have the option to support significant figures and/or propagation of error. The standard computation for the number of significant figures or a predefined number of significant figures available options for significant figures comprise options that preferred embodiments of the Equation Engine will support. Preferred embodiments will support “exact” values and “inexact values”. “Exact” values are values where irrational values are not approximated by decimal or other forms. For example, in exact values, irrational constants such as π and e (Euler's number) are left as those symbols and operations such as division and exponentiation (including, but not limited to roots) that would result in an irrational results are left in that form. Inexact values typically have all of the constants approximated and all operations that would result in an irrational number evaluated to a single typically decimal or scientific notation number. Preferred embodiments will support all bases including such popular bases as base 10, binary and hexadecimal.

Preferred embodiments supporting Geometry will provide all common postulates, theorems, corollaries, etc. Theorems, and where appropriate other constructs, will be subject to progressive revelation, i.e. will only be available to the student when appropriate. In many Geometry classes, a theorem may not be used until a formal proof for it has been given.

### Equation Input and Display in Apple Apps Using TextViews

The preferred embodiment of this invention when implemented on certain Apple devices can use XCode editable TextViews for users to enter their input and to display equations and expressions. Preferred embodiments will use one or more “composite TextViews”. One or more simple editable TextViews comprise a composite TextView. One or more of said composite TextViews typically comprise a composite composite editable TextView, used to input and display of equations that are easy to read and understand. There is no theoretical limit to the number of levels of nesting here. Navigation to the desired simple TextView within a composite TextView (or to the next composite composite TextView) can be (for example) by touching that TextView, mousing to it and/or by entering some keyboard key sequence that triggers the transition from one TextView to another. Repeating that sequence goes to the next and so forth, cycling through all of them or jumping over some of them. The figures used herein to illustrate various composite and composite composite TextViews often showing the outlines of each of the TextViews. Displaying those outlines can be used when editing parts of a composite TextView. Typically, when not editing a composite TextView the outlines will not be displayed. Exceptions to this comprise Above TextViews (referred herein as “aboves”) and Below TextViews (herein referred to as “belows”) where displaying the outlines can, in many cases, prove useful. Rather than displaying the outlines, it will often be more useful to use different colors for the foreground (typically text) and/or the background of the TextView. In general, many embodiments can provide the user the option to chose which outlines are to be displayed at what times. TextViews in a composite TextView that are empty are typically squeezed to zero thickness and/or zero height. When editing a composite TextView, all of its TextViews are shown with nonzero width and height so that values can be entered into them during editing. Those that are empty after editing are typically displayed as squeezed.

The composite TextViews illustrated herein are examples that illustrate the instant invention. Depending upon the details of implementation of TextViews, it might be useful to put an entire composite TextView inside a single TextView.

### User Supplied Equations

Some users, such as those with proprietary business equations or new equations being developed by researchers, will want to add equations not in the Equation Engine. The Equation Engine will provide means for users or other stakeholders to customize the Equation Engine by adding equations, variables, constants, data types and/or operators (and additional information as described above) not already in the Equation Engine.

### Equators

A new notation for equations is herein introduced that simplifies the manipulation of equations, especially in a computer-based environment. In virtually all cases, an Equator is an equation written as a fractional expression whose value is 1. For example, the Ideal Gas Law can be written as:

$$\frac{PV}{nRT}$$

and Gravitational Force Law can be written as:

$$\frac{G \cdot {m}_{1} \cdot {m}_{2}}{F \cdot {r}^{2}} .$$

Because each of them equals 1, their reciprocals also equal 1 and thus their reciprocals are also Equators. Virtually any equation can be written as a fraction equal to 1, and hence, as an Equator. Likewise, their reciprocals are Equators. The term “Equator” reflects the fact that the horizontal line demarks two equal entities (the numerator and the denominator) as the earth's equator is a “horizontal” line divides the earth into two equal parts. Also, all Equators are equal in value (1). An Equator multiplied or divided by a second Equator results in an Equator.

There are some equations that equal zero. These can be written as an Equator. For example, such as ∇·V=0 (in certain circumstances) can be written as

$$\frac{∇ \cdot V + 1}{1} .$$

When there might be ambiguity between non-Equator rational expressions and Equators, it will be useful to provide a symbol to designate an Equator, such as,

$$o \frac{PV}{nRT} or \frac{PV =}{nRT} .$$

The second notation is particularly useful with the analogs to Equators: Greators (where the numerator is greater than the denominator),

$$e . g . \frac{L \cdot h \cdot b >}{d \cdot {r}^{2}}$$

and Lessors (where the numerator is less than the denominator),

$$e . g . \frac{d \cdot {r}^{2} <}{L \cdot h \cdot b} .$$

Another notation for Greators and Lessors is to use two horizontal lines of unequal length between the numerator and the denominator rather than one, the longer horizontal line being atop the shorter one designating a Greator and the shorter horizontal line being atop the longer one designating a Lessor.

Because Equators equal 1, the product of two or more Equators is an Equator, an Equator divided by an Equator is an Equator and an Equator to the power of another Equator is an Equator.

The reciprocal of a positive Creator is a Lessor. The reciprocal of a positive Lessor is a Greator. The product of two positive Creators is a Greator. The product of two positive Lessors is a Lessor.

One application of Equators is to solve multi-state and/or multi-equation, problems through the use of multi-state and/or multi-equation Equators. Below is an example of the use of Equators in the solution of multi-equation problems. This example sets equal the centripetal force on an object orbiting another due to the electrostatic force between the two charged objects. Line “a” shows an Equator for centripetal force. Line “b” shows an Equator for a first and second Equator for Coulomb's Law. Line “c” sets up the product of Line “a” and the second Equator in Line “b”. Line “d” shows the Equators of Line “c” combined into one. But, R=r, therefore the Equator of Line “e”.

$$a . \frac{{F}_{centripetal} \cdot R =}{m \cdot {v}^{2}}$$

$$b . \frac{{F}_{Coulomb} \cdot {r}^{2} =}{k \cdot {q}_{1} \cdot {q}_{2}} therefore \frac{k \cdot {q}_{1} \cdot {q}_{2} =}{{F}_{Coulomb} \cdot {r}^{2}}$$

$$c . \frac{{F}_{centripetal} \cdot R =}{m \cdot {v}^{2}} \cdot \frac{k \cdot {q}_{1} \cdot {q}_{2} =}{{F}_{Coulomb} \cdot {r}^{2}}$$

$$d . \frac{{F}_{centripetal} \cdot R \cdot k \cdot {q}_{1} \cdot {q}_{2 =}}{{F}_{Coulomb} \cdot m \cdot {v}^{2} \cdot {r}^{2}}$$

$$e . \frac{{F}_{centripetal} \cdot k \cdot {q}_{1} \cdot {q}_{2 =}}{{F}_{Coulomb} \cdot m \cdot {v}^{2} \cdot r}$$

Euler.swift is a set of equation tools available online and under license from MIT. These tools include code that permits a Swift application to input, store, edit and display equations in a typeset style format. These tools can be used to implement those capabilities of the EE.

Preferred embodiments of the Equation Engine support input, of equations, equators, the values of constants, the definition of variable and more from other applications, local or remote and the output of these to other applications, local or remote. Said applications will include, but not be limited to, other copies of the Equation Engine, Excel and other math and engineering software.

### DESCRIPTION OF DRAWINGS

FIGS. 1A-1E illustrate a powerful way that composite TextViews can be used to input data and display an atom or monatomic ion in chemical expressions and/or equations in an embodiment of the Equation Engine.

FIGS. 2A-2D illustrate the use of multiple Element TextViews to create a Compound TextView for a molecule or polyatomic ion.

FIGS. 3A-30 illustrate molecules containing more than one of a given polyatomic ion. The aboves and belows are null in these figures, for simplicity.

FIG. 4 illustrates a Right Brace TextView and Left Brace TextView, analogous to the Right Parenthesis TextView and Left Parenthesis TextView described elsewhere herein.

FIGS. 5, 6A-6D, 7A-7C, 8A-8D illustrate TextViews that are useful for creating and displaying chemical equations on a computer-based display.

FIGS. 9, 10A-B, 11, 12A-B illustrate examples of Equation Engine mathematical expressions utilizing composite TextViews.

FIG. 13 illustrates an alternative navigation means utilizing a special keyboard subset.

FIG. 14 illustrates the Quadratic Formula.

FIGS. 15A-B illustrate examples of array display formats for entering and displaying a variable in an equation.

FIGS. 16A-F illustrate examples of array display formats for entering and displaying multiple variables in an equation.

FIG. 17 illustrates an example display with numerous means the EE provides for a user to select an equation to be solved.

FIG. 18 illustrates an example first operational screen on an Apple iPhone.

FIGS. 19-24 illustrate an example of the means whereby a user selects and solves an equation.

FIGS. 25-29 illustrate an example of the means whereby a user solves a problem by relating two equations.

FIGS. 25-29 illustrate an example of the means whereby a user solves a problem by relating two equations.

FIGS. 30-31 illustrate an example of the means whereby a user selects one or two equations using the variable/constant input array.

FIGS. 32-36 illustrate an example of the means whereby a user solves two-state equations.

FIGS. 37-38 illustrate an example of the means whereby a user solves the quadratic equation.

FIGS. 39-41 illustrate an example of the means whereby a user quickly computes a number of quantities regarding an input chemical species, such as a molecule, formula unit, ion, or element. It provides the mass of the species, the molar mass of each of its elements, the total molar mass of each element in the species, and the percent mass of each element in the species.

FIG. 42-48 illustrate the Factor Evaluator.

FIG. 49 illustrates an example of Apple Swift code that stores information needed for a given equation.

FIG. 50 lists pseudo-code for the algorithm for selecting an equation using the EE.

FIG. 51 lists pseudo-code for the algorithm for solving an equation using the EE.

### DETAILED DESCRIPTION

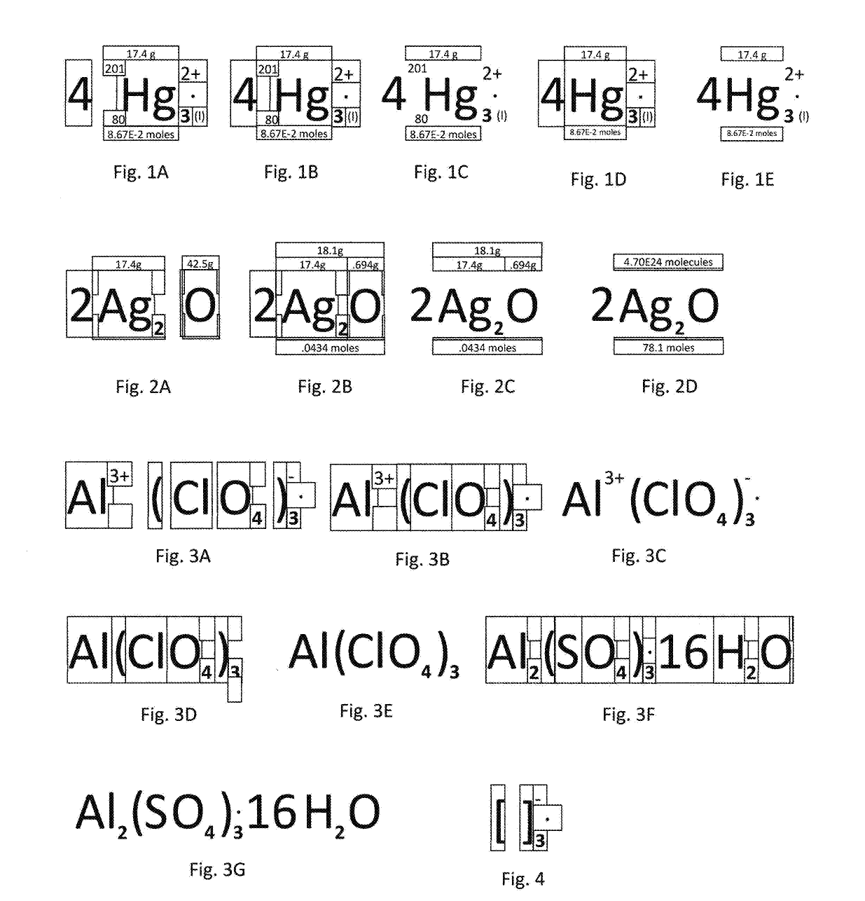

FIGS. 1A-1E illustrate a powerful way that composite TextViews can be used to input data and display an atom or monatomic ion in chemical expressions and/or equations in an embodiment of the Equation Engine. In a context where a chemical expression can be or is anticipated by the Equation Engine and the user enters a number (in this case a “4”) followed by the symbol for an element (or an “e”, as illustrated in FIG. 6E) in an undifferentiated Equation Engine TextView, the Equation Engine generates a particular type of composite TextView, an Element TextView comprising 8 or 9 connected TextViews. The number fills the optional Element Coefficient TextView and the symbol for the element (in this case “Hg”) automatically fills the Element Symbol TextView. If only the symbol for an element is entered (without the coefficient) into a TextView, an. Element TextView is generated, the Element Coefficient TextView is displayed as empty, but the value treated as 1. If the user then enters a value in the range of isotopic masses or the average mass of the specified element, that value (in this case “201”) automatically fills the

Element Atomic Mass pre-superscript TextView and the atomic number (in this case “80”) automatically fills the Element Atomic Number pre-subscript TextView as illustrated. If the user then enters a number, not followed by a sign (in this case a “3”) it automatically fills the Element Atomic Quantity post-subscript TextView and designates the number of the atoms or ions of this element are present. This can be the number of atoms of the element in a molecule or a polyatomic ion. If the user then enters a number, followed by a sign (in this case a “2+”) it automatically fills the Element Ionic Charge post-superscript TextView and designates the charge on each of the ions of this atom. If only the sign is entered, it is displayed and the absolute value of the charge is treated as 1. After entering the element symbol, if the user enters one of the state values such as “l”, “s”, “g”, “aq”, etc. that state value enters the illustrated. Element State TextView in parentheses. When in an Element TextView, a period is entered that is not part of an atomic mass TextView a raised dot automatically populates, an Element Dot TextView between the post-subscript and post-superscript. This is typically used to designate a hydrate. Note that which of these Element TextView fields is intended can be nearly always be inferred by its value. If there is ambiguity, the Equation Engine can make its best guess and the user can override it. Above the pre-scripts and symbol can be the “above”, an Element Above TextView that the user can use to designate the amount of that element in the reaction. Below the pre-scripts and symbol can be the “below”, an Element Below TextView that the user can use to designate the amount of that element in the reaction, or if that is designated in the above, it can designate the number of moles. Typically, the user can enter an amount in the above or in the below and the Equation Engine can calculate the other and fill it in. If the user wants the above or below computed and filled in and does not provide the above or below information for this element, the user can select that as a general option or simply enter a “?” in the requested field. In some embodiments, the Equation Engine will automatically compute and fill in element-level aboves and belows for all elements when not already specified. FIG. 1A illustrates the Element Coefficient TextView being separate from Element TextView to show its borders. Actually, Element Coefficient TextView it is part of the Element TextView as illustrated in FIG. 1B. FIGS. 1A and 1B show the borders of the Element's TextViews as lines. This is useful when editing the data for a given element. At other times, it is easier to read when, as illustrated in FIG. 1C, the outlines are not shown for all of the TextViews for an element with the probable exception of the aboves and/or belows. FIGS. 1A, 1B and 1C illustrate the display of the element when the atomic mass and/or number are to be displayed. FIGS. 1D and 1F illustrate the display of the element when neither the atomic mass nor atomic number is to be displayed. In this case, the TextViews for those fields are squeezed to zero width, allowing the coefficient to be closer to the atomic symbol. FIGS. 1A-1E also illustrate how different measures of the substance can be in the aboves versus the belows. Thus, when the user enters “4Hg2+3l.”, the Element TextView illustrated in FIG. 1E is generated and populated, only the aboves and belows are not populated. The user can enter a value in the Element Above and/or Below or the Molecule Above and/or Below to get the Element Above and/or Below populated.

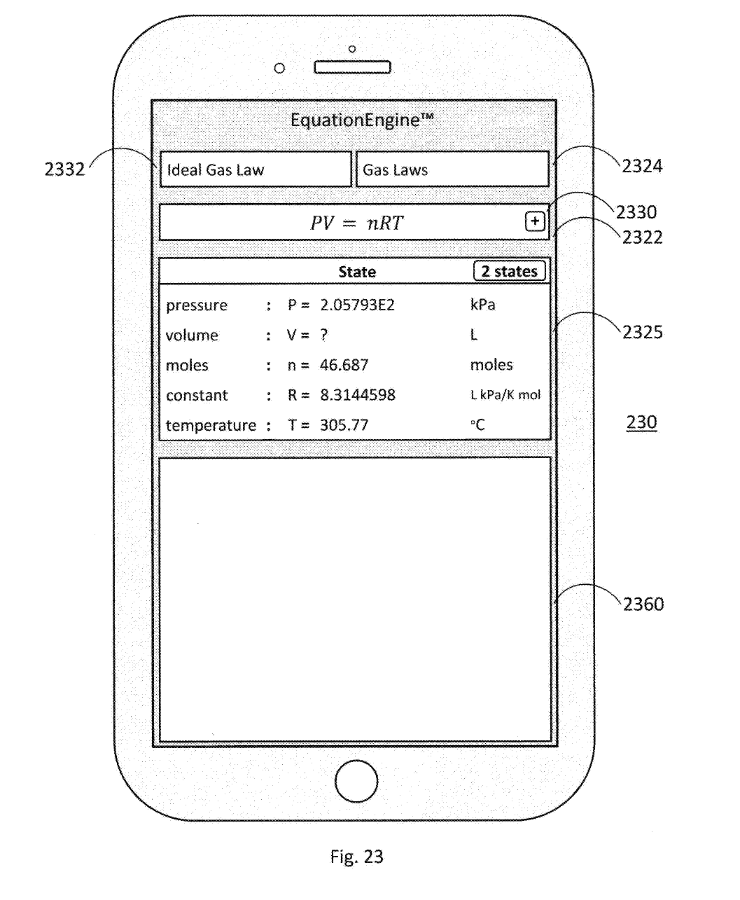

FIGS. 2A-2D illustrate the use of multiple Element TextViews to create a Compound TextView for a molecule or polyatomic ion. FIG. 2A illustrates two Element TextViews separated for clarity. They are not typically displayed separately in the preferred embodiments. FIGS. 23-2D illustrate the concatenation of those two element TextViews to create a Compound TextView. An additional feature illustrated in FIGS. 2A-2D are aboves and belows for the amounts associated with the designated molecule or polyatomic ion. The Element prescript TextViews in both elements are shrunk as they are mused, but illustrated. The post-subscript for Ag is present. All of the other postscripts are unused, but illustrated. The coefficient for O, while shown as shrunken, will actually have no width as it is empty (but interpreted as having a value of 1). Note that the values for the masses of Ag and O are included in their respective aboves and will have been entered by the user or computed by the Equation Engine. FIGS. 2B and 2C illustrate that the data in the above for O has been changed by the Equation Engine to reflect that in the compound. The 0.694 g of O corresponds to the 17.4 g of Ag which is the limiting reactant in the formation of the silver oxide. FIGS. 2B and 2C also illustrate the total mass of the silver oxide in the Compound Above TextView and the number of moles of the compound in the Compound Below TextView, based upon the mass of the limiting reactant. FIGS. 2A-2D illustrate an example where the Element Below TextViews are all null. The Element Below TextViews are empty, but shown with a nonzero height. In preferred embodiments, those heights are zero, unless an Element TextView is selected for editing. In that case, it will have a finite height to permit the user to enter data therein. FIGS. 2C and 2D illustrate the outlines of the TextViews not being displayed except for the Element Above and Below TextViews and the Compound Above and Below TextViews. The null Element Below TextViews in FIGS. 2C and 2D and the Element Above TextView in FIG. 2D are illustrated as having a nonzero height for purpose of illustration. The only time that null aboves and belows have a finite height is when they are selected for editing. When the user enters “2Ag20”, the Compound TextView illustrated in FIG. 2D is generated, without values hi the Compound Above and Below.

FIGS. 3A-3G illustrate a molecule containing more than one of a given polyatomic ion. The aboves and, belows are null in these figures, for simplicity. FIG. 3A illustrates a separation between the A1 Monatomic Ion TextView, the Left Parenthesis TextView, the perchlorate TextView, and the Right Parenthesis TextView. The separation between these TextViews is for illustration purposes and will not appear in preferred embodiments. Note that the Right Parenthesis TextView includes a post superscript TextView, a “dot” TextView, and a post subscript TextView comprise the Right Parenthesis TextView. FIG. 3B illustrates the TextViews in their normal orientation, but with all of the TextViews outlined, which is only the case when editing the molecule. FIG. 3C illustrates the normal display of the molecule while displaying the charges on the ions and the dot which will typically be used only when followed by a coefficient and “H2O”, designating a hydrate. FIGS. 3D and 3E illustrate the molecule without displaying the charges on the ions. When the user enters “Al(ClO4)3”, the Compound TextView illustrated in FIG. 3E is generated. In an alternative embodiment, when the user enters a left parenthesis, the left parenthesis is generated along with its matching Right Parenthesis TextView, with the cursor between the pair of parentheses. When the user enters “Al2(SO4)3.16H2O” the EE generates a compound TextView. FIG. 3F illustrates what said compound TextView would look like if the borders were displayed to the user. FIG. 3G illustrates how said compound TextView is typically displayed to the user.

FIG. 4 illustrates a Right Brace TextView and Left Brace TextView, analogous to the Right Parenthesis TextView and Left Parenthesis TextView described elsewhere herein.

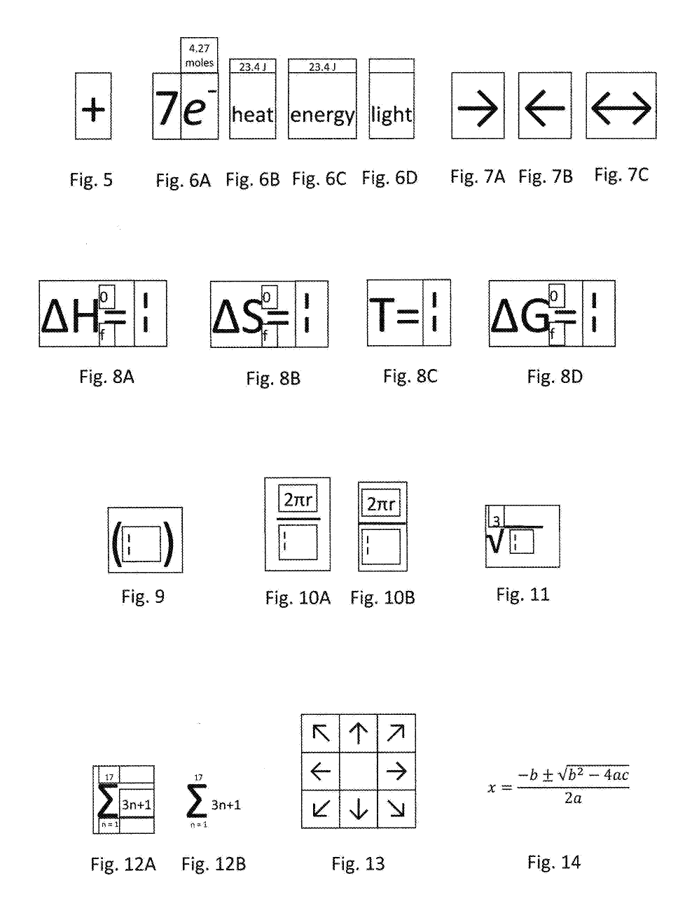

FIGS. 5, 6A-D, 7A-C, 8A-D illustrate TextViews that are useful for creating and displaying chemical equations on a computer-based display. When entering a chemical equation, when the user enters “+”, (as FIG. 5 illustrates) the TextView containing a plus sign is generated and typically goes between reactants or products in chemical equations. If after a Plus TextView, the user enters an “e” or an integer immediately followed by an “e”, an electron TextView, as illustrated in FIG. 6A, is generated. The charge and the above and below TextViews are automatically generated. When entering a chemical reaction, if the user enters “heat”, “light”, or “energy” a TextView is generated, as illustrated in FIGS. 6B-6D respectively, including an above and/or below for the user to enter information about that “reactant” or “product”, such as the quantity or type (such as the frequency of the light). When entering a chemical reaction, if the user enters “->”, “<-” or “<->” a TextView is generated, as illustrated in FIGS. 7A-7C respectively. These symbols separate the reactants from the products and indicate the direction of the reaction. FIGS. 8A-8D illustrate TextViews for entering thermodynamic information in chemical reactions. When entering a chemical reaction, if the user enters “dH0f=”, a TextView as illustrated in FIG. 8A is generated and the cursor is as illustrated allowing the input of a value with units. This value is treated as the standard heat of formation for the reaction. When entering a chemical reaction, if the user enters “dS0f=”, a TextView as illustrated in FIG. 8B is generated and the cursor is as illustrated allowing the input of a value with units. This value is treated as the standard entropy for the reaction. This value is treated as the standard Gibbs Free Energy for the reaction. When entering a chemical reaction, if the user enters “T=”, a TextView as illustrated in FIG. 8C is generated and the cursor is as illustrated allowing the input of a value with units. This value is treated as the temperature for the reaction. When entering a chemical reaction, if the user enters “dG0f=”, a TextView as illustrated in FIG. 8D is generated and the cursor is as illustrated allowing the input of a value with units. This disclosure makes it clear that the full range of symbols used in Chemistry and all other areas can be generated and navigated.

In preferred embodiments of the Equation Engine, any of the Equation Engine TextViews may be entered in any other Equation Engine TextView. However, the precedence for interpretation of which TextView is being entered is determined by what is most likely in the given context.

FIGS. 5, 6A-D, 7A-C, 8A-D, 9, 10A-B, 11, 12A-B display the outlines of the TextViews comprising their respective composite TextViews. As mentioned elsewhere herein, those outlines are shown for clarity. Those outlines might be visible during editing, but typically will not be displayed otherwise.

FIGS. 9, 10A-B, 11, 12A-B illustrate examples of Equation Engine mathematical expressions utilizing, composite TextViews. In a TextView, when a user enters “(”, it triggers the generation of a Parenthesis Pair TextView as illustrated in FIG. 9 with a left parenthesis, aright parenthesis and the cursor (as illustrated by the “¦”) in a Parenthesis Pair Internal TextView for everything within the parentheses. If a second Parenthesis Pair TextView is entered inside a first Parenthesis Pair Internal TextView, the Equation Engine can color code the parentheses such that left and right parentheses of the outermost pair of parentheses are one color, the first inner level of parentheses a second, but different color, etc so that it is easy to determine which parentheses match each other.

In a TextView, when a user enters “(2πr)/”. The “/” triggers the generation of a Rational Expression Text View as illustrated in FIG. 10A and FIG. 10B with the cursor in the denominator TextView as illustrated by the “¦”. The parentheses around the “2πr” will cause that entire expression to populate the numerator TextView of this Rational Expression TextView. FIG. 10B illustrates a Picket Pence Rational Expression TextView which can be used to generate Picket Fence strings of factors as used by some in Dimensional Analysis problems. Normal rational expressions and the last rational expression in a picket fence display will typically use Rational Expression TextViews as illustrated in FIG. 10A. To generate a rational expression TextView displaying the numerator next to the denominator e.g. “a/b”, the user might, for example, enter “a/b” to distinguish it from the display illustrated in FIG. 10A.

Operators, such as the root or radical symbol, can be selected by entering a string, such as “sqrt” or by selecting it from an array of operators. Either way, the Radical TextView, as illustrated in FIG. 11, is generated. The cursor is within the TextView under the radical, symbol. To enter data in the TextView that designates the root (illustrated as populated by a “3”), the user can, for example, select that TextView by touching it, mousing to it, or entering a key sequence, such as an “ESC” character. An alternative means for a user to specify a composite TextView is to select it from a menu various composite TextViews of from a specialized keyboard displayed by the Equation Engine.

Likewise FIGS. 12A and 12B illustrate the use of composite TextViews to simplify the entry and display of expressions. The Sigma TextView can be selected by entering a string, such as “sigma” or by selecting it from an array of operators. Either way, the Sigma TextView, as illustrated in FIGS. 12A and 12B, is generated. The Sigma TextView comprises six TextViews, the TextView that contains the sigma symbol and the other five TextViews. Two TextViews are below the sigma, two are above the sigma and one TextView is to the right of the sigma. When the Sigma TextView is generated, the cursor is within the TextView under the sigma symbol. When the user is done entering in that TextView, the user can enter “return” (or some other key sequence) and will be placed in another TextView. This process is repeated for a standard sequence of TextViews until complete. This is called Cyclic Navigation as the Equation Engine cycles through the TextViews that make up the composite TextView. The user can edit a specific TextView in the Sigma TextView by directly selecting that TextView.

An alternative means for navigation is to employ a special character to designate where the user wants to navigate next. For example, when the user types “̂”, the Equation Engine can generate a TextView for a superscript. When in the superscript, if the user enters another “̂”, a superscript to the current superscript can be generated.

FIG. 13 illustrates an alternative navigation means utilizing a special keyboard subset. The up-right arrow navigates to or creates the post superscript and moves the cursor to the post superscript. The down-right arrow navigates to or creates the post subscript and moves the cursor to the post subscript. The up-left arrow navigates to or creates the pre-superscript and moves the cursor to the pre-superscript. The down-left arrow navigates to or creates the pre-subscript and moves the cursor to the pre-subscript. The up arrow navigates to or creates the above and moves the cursor to the above. The down arrow navigates to or creates the below and moves the cursor to the below. The center box navigates to the center TextView or creates and moves the cursor to the center TextView. Alternatively, once the composite TextView is created, the user can tap the appropriate sub TextView or the user can swipe in the direction roughly corresponding to the direction of the arrows.

The Equation Engine can determine from the input text stream which of the TextViews comprising an Element TextView is to be filled with which input text. In general, the Equation interprets input strings as they would be verbalized and/or entered into a calculator and display the equation as it is typically illustrated in books for the appropriate discipline. For example, the Quadratic Formula can be entered as x=(−b+−sqrt(b̂2−4ac))/(2a) and displayed as illustrated in FIG. 14. The space between the first “2” and the second “-” tells the Equation Engine that the “-” is not in the exponent with the “2”. In preferred embodiments, the input string and the equation as illustrated in FIG. 14 are both displayed and the user can edit either with the changes propagated to the other. This is true for all pairs of input strings and their Equation Engine representations.

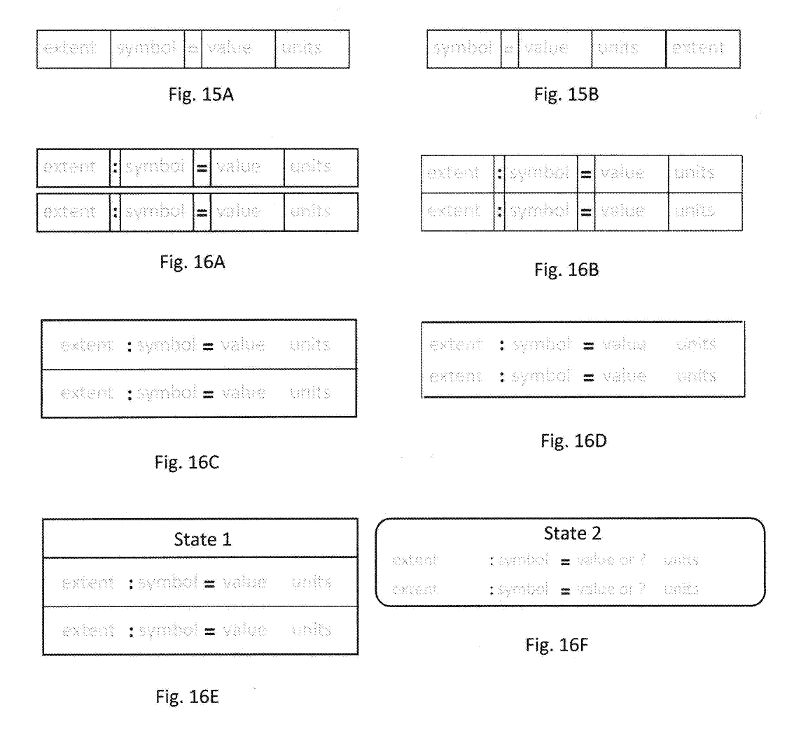

FIGS. 15A-B illustrate two examples of means to display the properties of a variable in an equation. Both illustrate fields for entering and/or displaying the extent, symbol, value, and units of one variable in an equation. FIG. 15A illustrates a row of fields where the extent field is first, the symbol field as used in the desired equation, an “=” sign, a field for entering/displaying the value of that variable, and a field for entering/displaying the units that the user wants to use. In this, and in all similar rows, the user can enter the extent, the symbol, and/or the units, typically providing enough information for the EE to select the relevant equation. When that is not enough information to reduce the number of relevant equations to one, it will be enough for the EE to display all possible equations meeting those constraints. The user can then directly select the equation to use. FIG. 15B is the same as FIG. 15A, except the extent field is moved to the end of the row. Each field's border is displayed to simplify distinguishing between them. Field borders can be shades of grey, rather than black to tweak distinguishing between fields and simplifying the visible display. Variants, illustrated elsewhere herein, do not display the borders of each of the fields in a row.

FIGS. 16A-F illustrate examples of array display formats for entering and displaying, multiple variables in an equation. FIG. 16A illustrates multiple rows, one for each variable, similar to that described in FIG. 15A, except that a “:” is between the extent field and the symbol field. Each row is separate, with separate top and bottom borders. FIG. 16B illustrates multiples rows, like FIG. 16A, except that the bottom border of the top row is the same as top border of the bottom row. FIG. 16C illustrates multiples rows, like FIG. 16B, except that the borders between the fields in each row are not displayed. FIG. 16D illustrates multiples rows, like FIG. 16C, except that the borders between the rows are not displayed. FIG. 16E illustrates multiples rows, like FIG. 16C, except that a field is added above the first variable row that designates which state that this set of variable rows refers to. FIG. 16F illustrates multiples rows, like FIG. 16D, except that a field is added above the first variable row that designates which state that this set of variable rows refers to and has rounded border corners and there is no line between the State designation field and the first variable row.

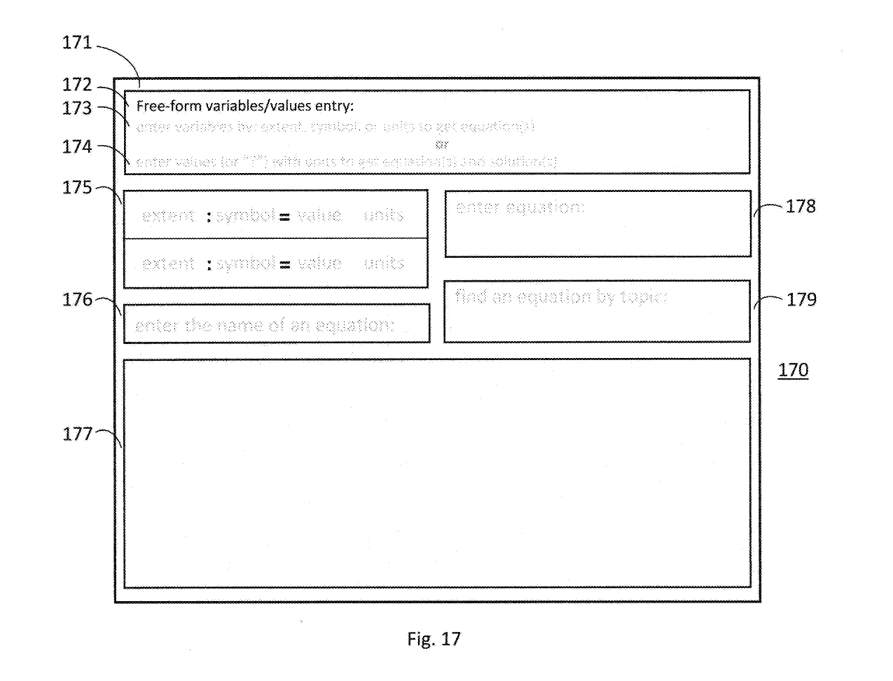

FIG. 17 illustrates 170, a subset of a display embodying numerous means the EE can provide for a user to select an equation to be solved. Free-form variables/values entry TextView 171 contains placeholder line 172 “Free-form variables/values entry” explaining that this field is for entering variables and/or values freeform. TextView 171 also contains placeholder line 173 informing the user that if he enters variables by “extent, symbol or units” the EE can display the needed equation. TextView 171 also contains placeholder line 174 informing the user that if he enters “values (or ‘?’) with units”, the EE can determine what equation is needed and solve the equation for the unknown. If the units entered in 171 don't determine a unique equation, the limited number of equations that meet those constraints will be displayed. The user can then choose which of the displayed equations for the EE to solve. TextField 175 contains the placeholder “enter the name of the equation:”. The EE matches the input string to the closest equation name. The keyboard is designated by 177. TextField 178 contains the placeholder “enter equation”. The EE matches the input string to the closest equation in symbolic form. TextField 179 contains the placeholder “find an equation by topic:”. The EE matches the input string to equations that match that topic and displays them for final selection by the user. Array of TextFields 175 can be any of the arrays of variable rows as exemplified in FIG. 16. EE can use autofill in any or all of these input fields, with the exception of the “value” fields. An embodiment of the EE combines fields 171, 175, 178, and 179 in a single TextView. In that case, the EE would determine whether the input was: an equation name; an equation topic; variables by extent, symbol or units; or values with units.

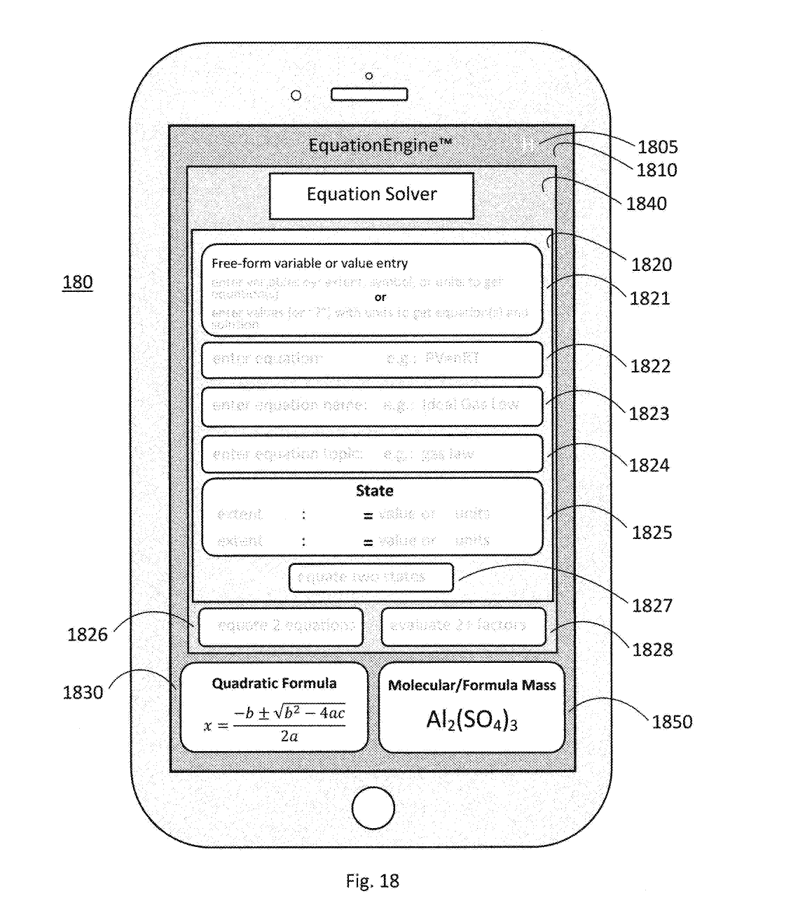

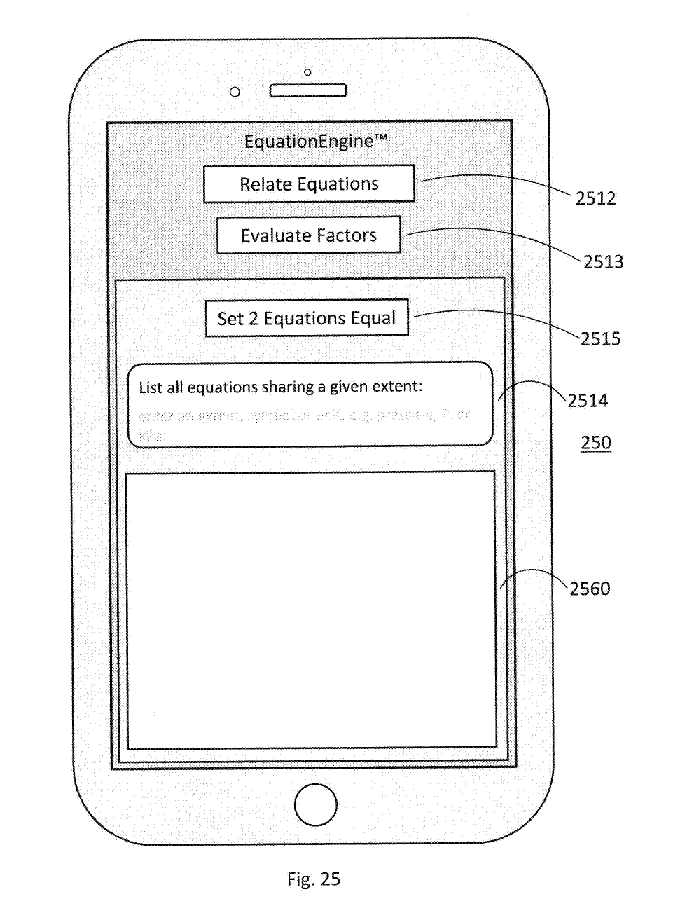

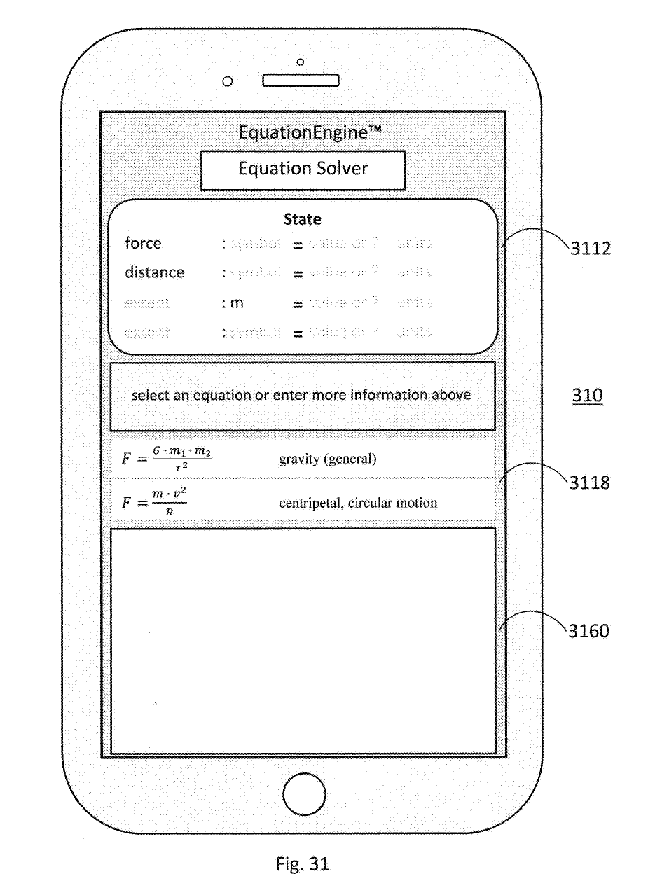

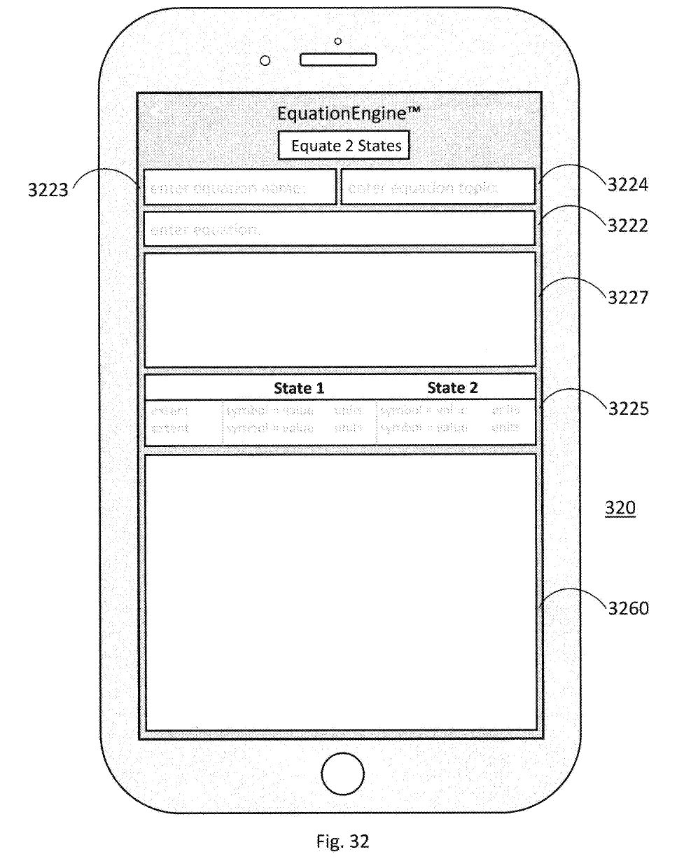

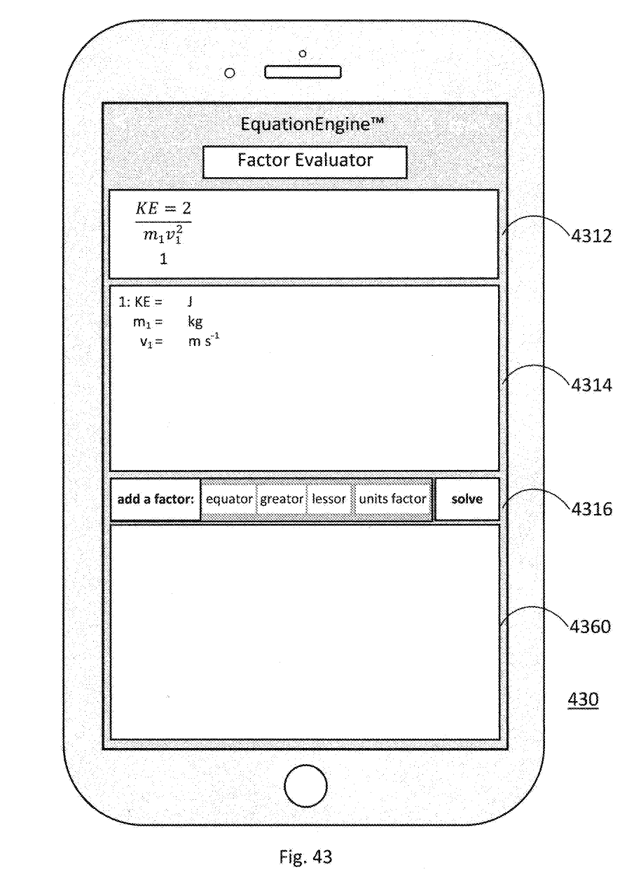

FIG. 18 illustrates an example first operational screen 180 on an Apple iPhone. Overall background 1810 supports three subdivisions 1830, 1840, and 1850. Tapping History button 1805 invokes the display of past screens of solutions. Everywhere herein where the white “H” is displayed represents a History button. The background for the tools for selecting equations, comparators, and units factors (Equation Solver) is 1840. The background for the tools for selecting a single equation is 1820. To quickly access solving problems using the quadratic formula, the user can tap button 1830. To quickly access the EE's chemistry-related computations, such as the EE's computation of molecular mass or formula mass of an element or compound, the user can tap button 1850. The user can tap button 1821 to access tools like TextView 171. The user can tap button 1822 to access tools like TextField 178. The user can tap button 1823 to access tools like TextField 176. The user can tap button 1824 to access tools like TextView 179. The user can tap button 1825 to access tools like TextField array 175. The user can tap button 1826 to access tools to relate two equations like those illustrated in FIGS. 25-29. The user can tap button 1827 to access tools to relate two states of one equation like those illustrated in FIGS. 32-36. The user can tap button 1828 to access tools to manipulate factors like comparators and units factors like those illustrated in FIGS. 43-49.

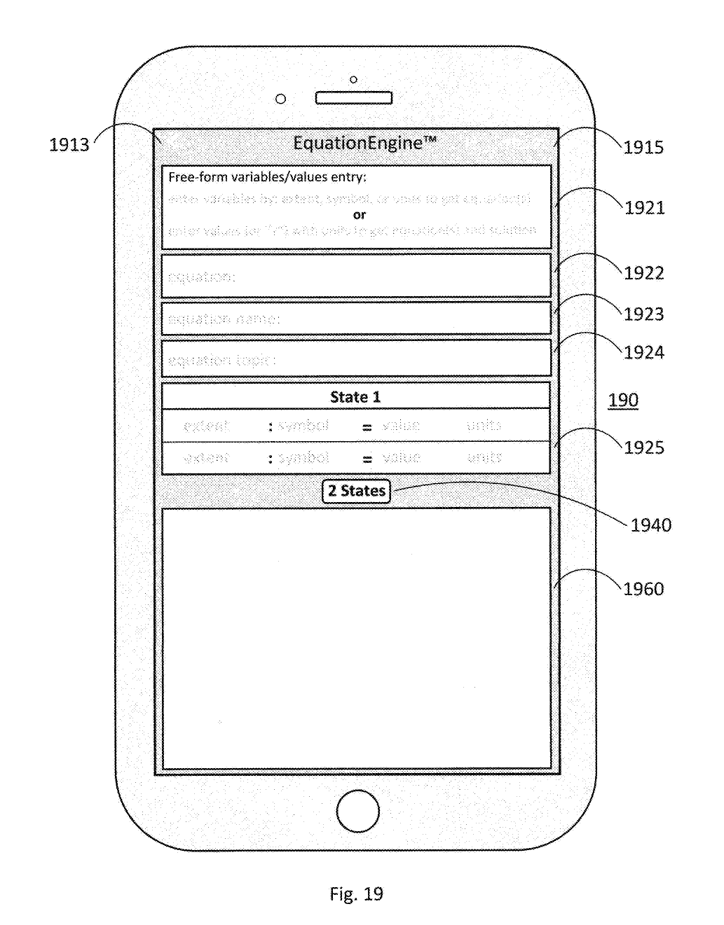

FIG. 19 illustrates an example of the screen displayed when button 1821 is tapped. The EE places the cursor at the upper left corner of editable TextView 1921. Tapping button 1913 causes the screen to return to FIG. 18. Herein, whenever the white “<” is displayed, it is intended to be a button that takes the user back to the screen that invoked it and in the state it was in at the time of the invocation. In the app, this “white” “<” is blue in keeping with Apple's standard. Tapping “reset” button 1915 causes all of the user-entered input on this screen to be deleted and the cursor returned to the location beginning of the field that it was in at the time button 1915 was tapped. Herein, whenever a white “reset” is displayed, it is intended to have the same effect. Tapping button 1940 causes the EE to display a screen like FIGS. 32-36. As the user taps the keys on virtual keyboard 1960 to enter input into one of the input fields, the others are updated when possible. The “H” and “reset” buttons will typically be displayed in blue in an app. When the user sees the equation sought displayed in 1922 or its name in 1923, he can tap that field to select that equation and the EE will display a screen like 220 or 230, depending upon the amount of data collected. At any point, the user can tap on 1925 and the EE will display a screen like 220 or 230. If there is sufficient data in 1925, the EE will solve the equation and display a screen like 240.

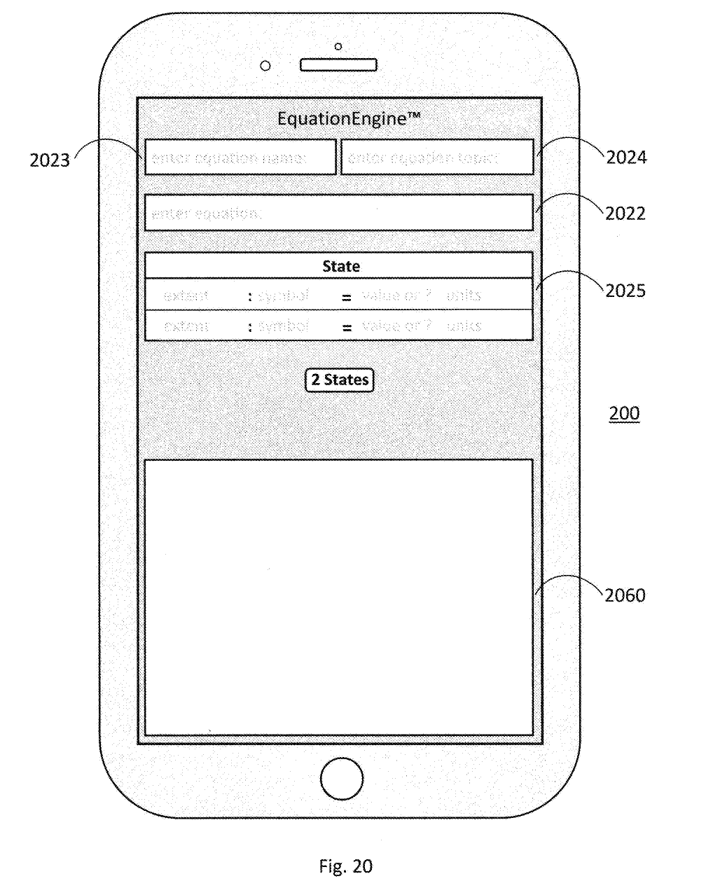

FIG. 20 illustrates 200, an example of the screen displayed when button 1822, 1823, 1824 or 1825 is tapped. The EE places the cursor in the corresponding editable TextField or TextView 2022, 2023, 2024 or 2025 respectively. As the user enters input using virtual keyboard 2060 other fields are filled in as soon as possible.

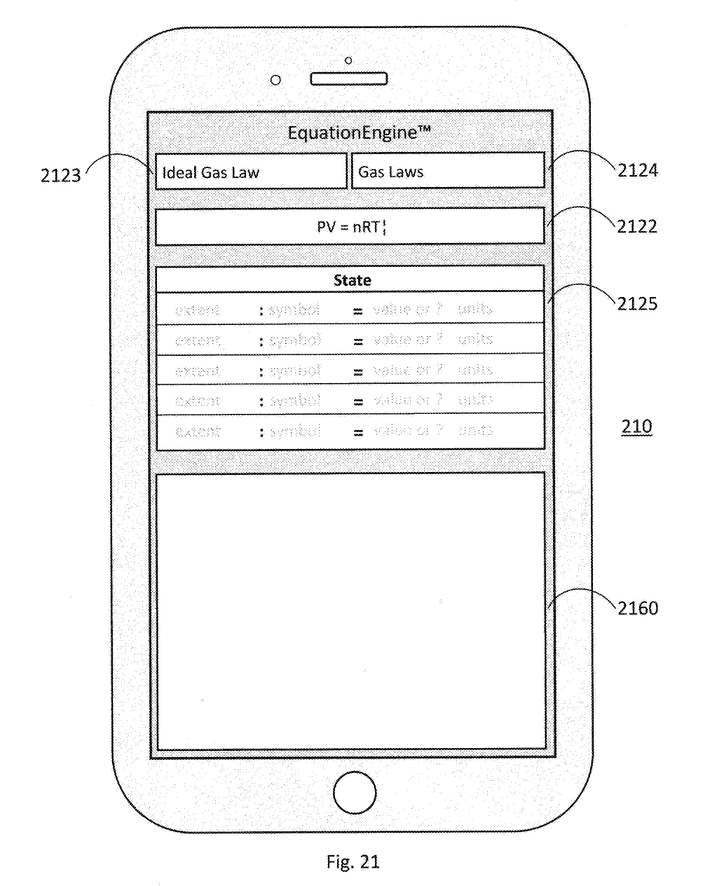

FIG. 21 illustrates 210, an example of the screen 200 displayed after button 1822 is tapped. The EE places the cursor in the editable TextField or TextView 2122. As the user enters “PV=nRT” (the cursor is shown to the immediate right of the “T”) using, virtual keyboard 2160 fields 2123 and 2124 are filled in.

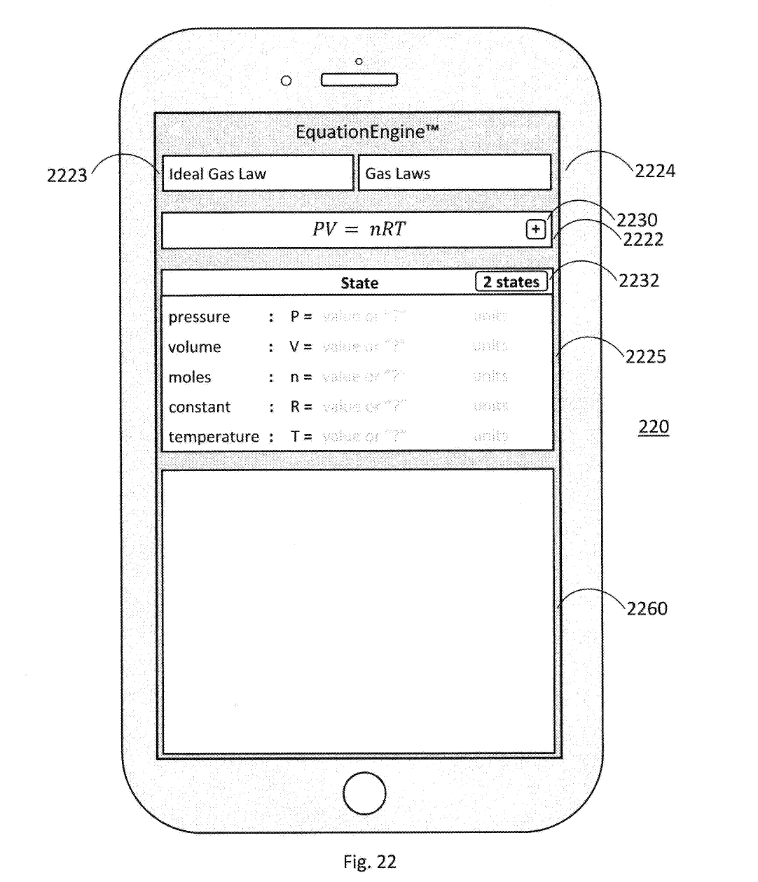

FIG. 22 illustrates 220, an example of the screen 210 displayed after the user enters “return”. The equation in TextField 2222 is reformatted in a typeset form. In 2222 and everywhere herein, whenever an equation is displayed, tapping it will cause it to be displayed as an equator. Likewise, in 2222 and everywhere herein, whenever an equator is displayed, tapping, it will cause it to be displayed as an equation. Thus, tapping an equation or equator will cause it to toggle between the two. In 2222 and everywhere else herein, whenever an equator is displayed, swiping up on it will cause its inverse to be displayed. Variable input array 2225 has been expanded to 5 rows, one row for each variable and constant. The extents and symbols for those variables and the constant are automatically filled-in. The value and units of “R” are not filled-in because the value and units of “R” depend on the units of the variables as selected, by the user. Alternatively, the EE can fill-in the units that are standard for this equation. In this case, the value and units of “R” can be automatically filled-in by the EE. Note also that lines are no longer displayed between the variable input rows. As detailed above, many variants of this field are possible. Different variants might be preferred at different stages of the input process. The cursor now will be automatically placed in the beginning, of the value field of the first variable input row, in this case to the right of “P=”. Virtual keyboard 2260 is used to enter data in these fields. Button 2230 when tapped causes a pop-up to display. Said pop-up provides a means to select more information on this equation as listed elsewhere herein.

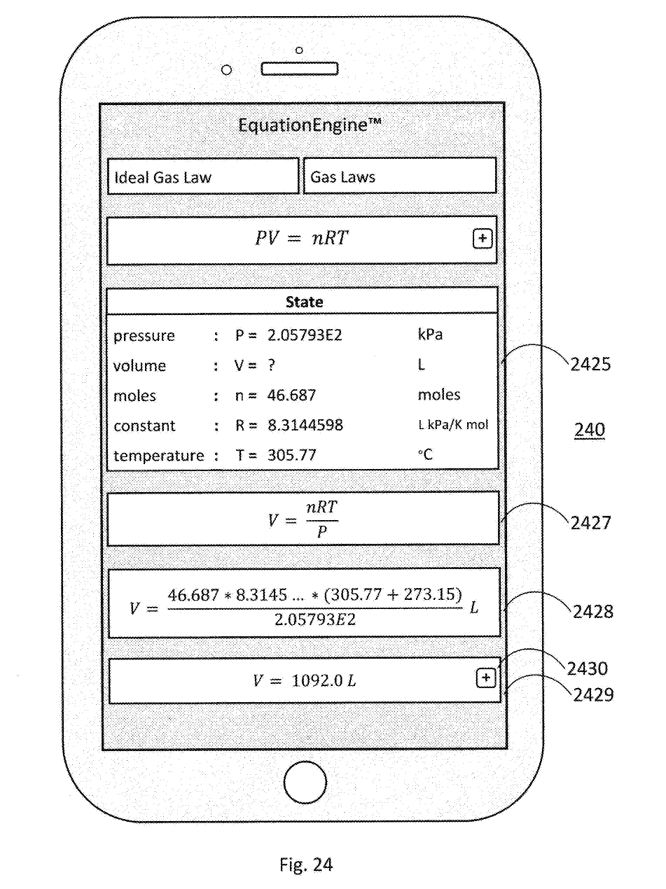

FIG. 23 illustrates 230, an example of the screen 220 displayed after the user has provided the value and units information needed for each of the variables and just before the EE automatically solves and displays the equation (see FIG. 24). 2360 is the virtual keyboard. Note that an alternative is to display the units right next to the values. One way to implement this to determine the width of the value TextField, then make the xOrigin of the units field equal to the xOrigin of the value field plus the width of the value field. The “?” in variable input array 2325 indicates that the volume of the gas sample is the unknown.

FIG. 24 illustrates 240, an example of the screen 230 displayed after the user has provided the value and units information needed for each of the variables and just after the EE has automatically solved and displayed the equation. The virtual keyboard has been dismissed. UILabel 2427 displays the equation solved for the unknown (“V”). UILabel 2428 displays the equation solved for the unknown (“V”) with the symbols of the variables and the constant substituted with the values of the variables and the constant. The “+273.15” illustrates that the temperature, input as degrees Celsius, needed to be converted to Kelvin to achieve the correct solution. The “ . . . ” designates that the value for “R” is rounded to save space. Transparently to the user, the EE converts all input values to the EE's standard units for the given equation, solves the equation, then converts the solution to the units selected by the user for the solution. UILabel 2429 displays the solved value and units and correct number of significant figures for the unknown. The EE uses the number of significant for each input value and stored (or input) constant and the standard rules for calculating the number of significant figures to determine the correct number of significant figures for the solution. Tapping button 2430 causes the EE to display a pop-up window with many more figures beyond those with significance. This is needed as problems presented in books and/or by teachers often do not use decimal points well, resulting in solutions with only one or two significant figures. This pop-up also provides means for the user to store the value and units and to associate them with a name that can be used as input in any appropriate location in embodiments of the EE. Herein, wherever a solution is displayed, it can be tapped or the “+” horizontal to it can be tapped to invoke said pop-up.

FIG. 25 illustrates 250, an example of the screen displayed after the user has tapped button 1826 or otherwise selected to relate two equations. UILabel 2512 informs the user that the current operation is to “Relate 2 Equations”. Editable UITextView 2514 has a placeholder requesting the user to “enter an extent, symbol or unit, e.g. pressure, P, or kPa:” and the EE will “List all equations sharing a given extent”. The user employs virtual keyboard 2560 to enter that input.

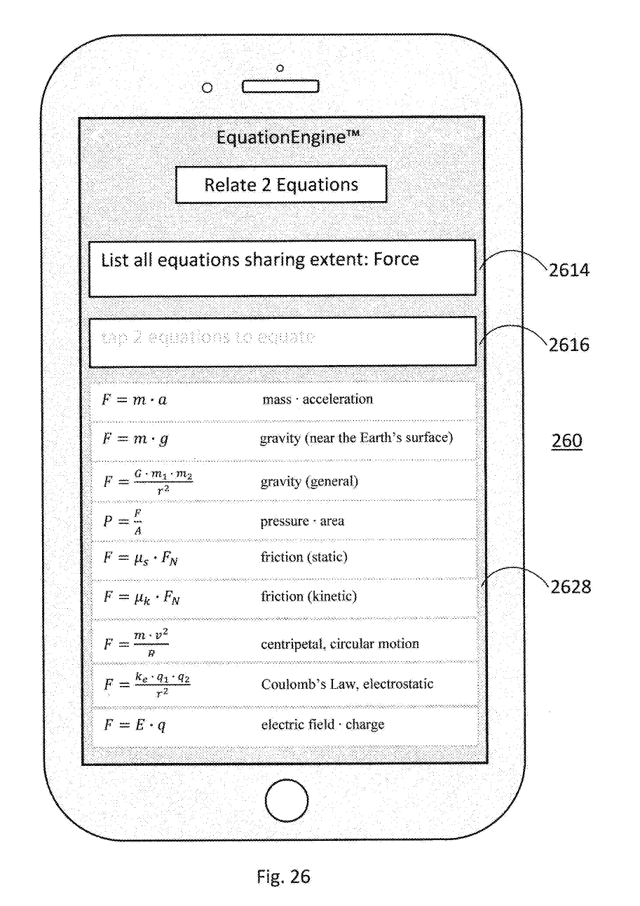

FIG. 26 illustrates 260, an example of the screen displayed after the user has entered “Force” return. The virtual keyboard 2560 is retired. Noneditable UITextField (or UILabel) 2614 provides feedback showing the extent selected by the user, in this case “Force”. UILabel 2616 instructs the user to “tap 2 equations to equate”. Vertical scrolling UIScrollView 2628 lists all available equations containing the selected extent, in this case “force”. Being a UIScrollView, the user can scroll vertically through the list to see and select equations that are not currently in view.

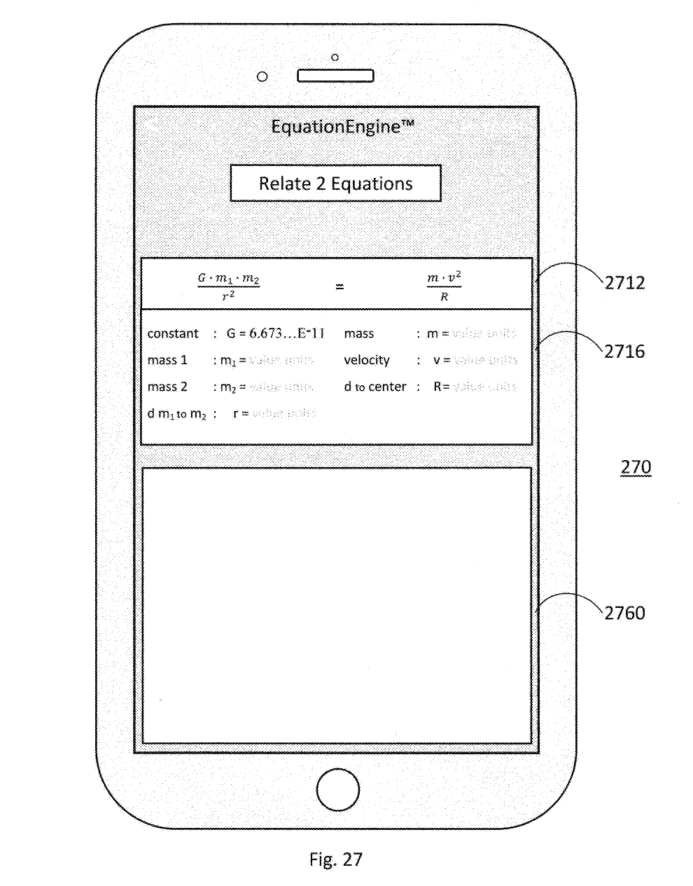

FIG. 27 illustrates 270, an example of the screen displayed after the user has selected equations

$$“ F = \frac{G \cdot {m}_{1} \cdot {m}_{2}}{{r}^{2}} ” and “ F = \frac{m \cdot {v}^{2}}{R} ” .$$

UILabel 2712 shows the gravitation force set equal to the centripetal force. Two variable input arrays are displayed in editable UITextField array 2716, the left one for the gravitational force equation and right one for the centripetal force equation. The user will employ virtual keyboard 2760 to enter the values and units for the displayed variables. If

$$“ P = \frac{F}{A} ”$$

had been selected, it would have been displayed as “P*A” as relating the equations requires that they both be solved for the same extent, in this case “force”.

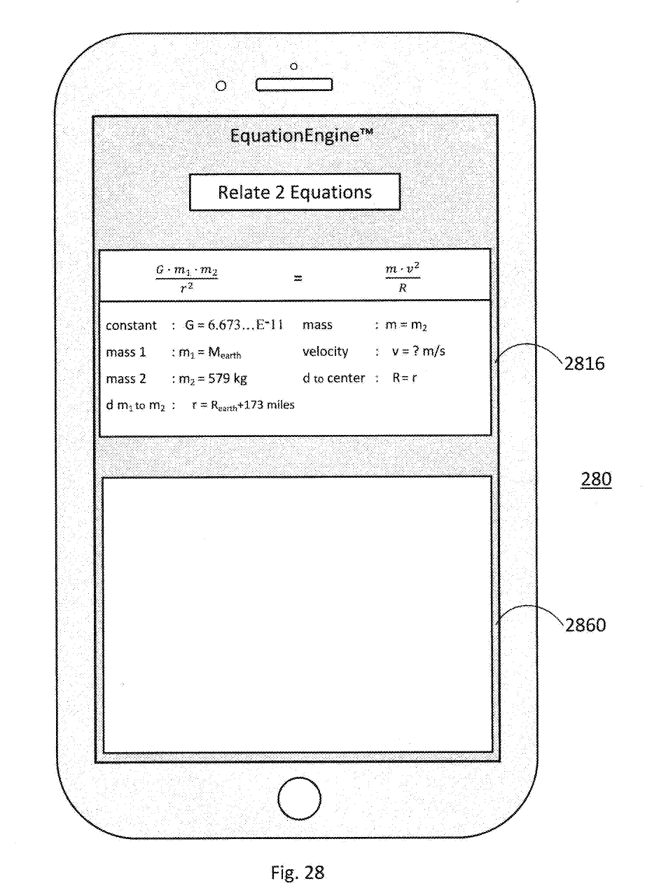

FIG. 28 illustrates 280, an example of screen 270 displayed immediately after the user has filled-in the two editable UITextField arrays in 2816 and before the EE has computed the solution. When the user enters “Mₑₐᵣₜₕ” in the mass 1 field's value UITextField, it is automatically reformatted to “Mₑₐᵣₜₕ,” and interpreted as the mass of the earth. The actual value and units are not displayed here. Likewise, when the user enters “Rearth” it is automatically reformatted to “Rₑₐᵣₜₕ” and interpreted as the radius of the earth. Note that the user can perform operations in the value field, e.g. “±173 miles”. Also, one value can be set to another as illustrated “m=m₂”. This sets “m” to 579 kg. The “? m/s” indicates that the velocity is the unknown and the units that the solution is to be computed and displayed in m/s. The user inputs data using virtual keyboard 2860.

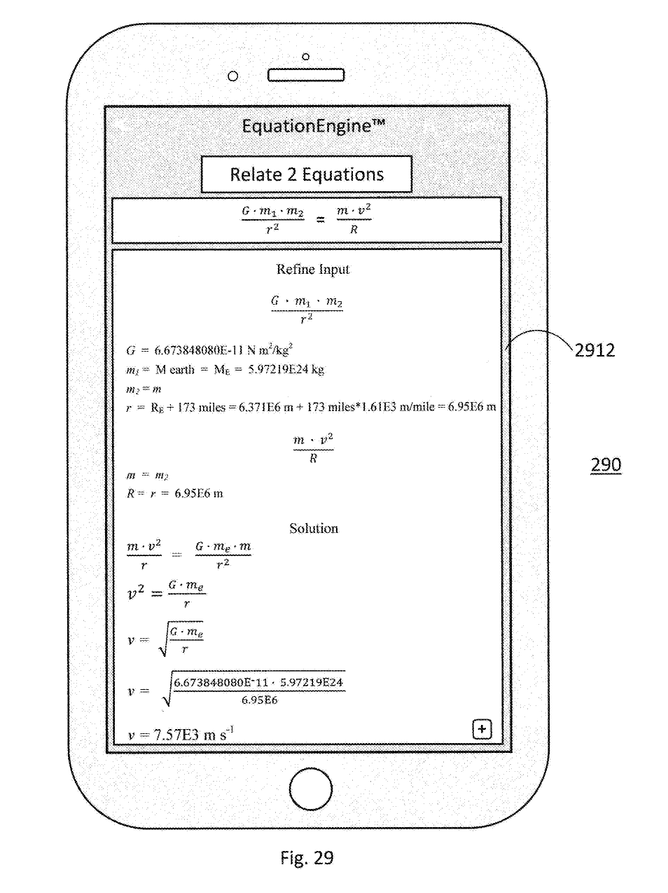

FIG. 29 illustrates 290, an example of screen 280 displayed after the user has filled-in the two editable UITextField arrays in 2816 and after the EE has computed the solution. UILabel or UIScrollView 2912 displays the “Refine Input” and “Solution” phases in the solution process. The “Refine Input” phase translates all input into EE standard units. Here, “m₁” vas set equal to “Mₑₐᵣₜₕ” by the user and converted to 5.97219E24 kg by the EE. “r” was set equal to “Rₑₐᵣₜₕ+173 miles” by the user, then to 6.95E6 m by the EE, with the conversion arithmetic shown. “m” was set equal to “m₂” by the user, the value and units of “m₂”. “R” was set equal to “r” by the user and hence to 6.95E6 m as computed above. In the solution phase, the symbolic representations of the equations are set equal with equal variables given the same symbol. The next line illustrates the simplified equation. The next line shows the equation solved for the unknown variable in symbols. The next line shows the equation solved for the unknown variable with the values substituted for the symbols. The final line shows the unknown variable solved and displayed in the user-selected units.

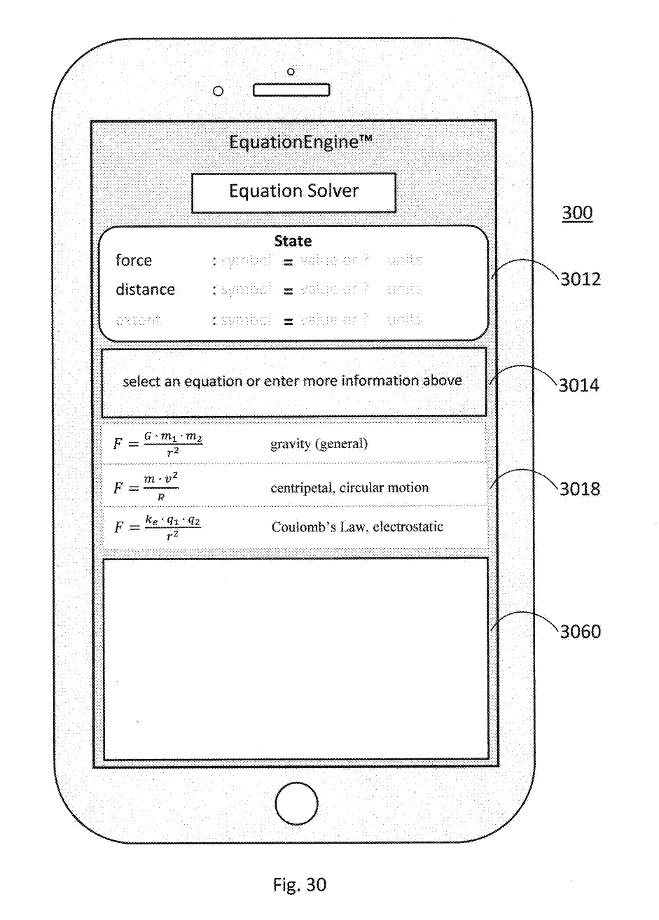

FIG. 30 illustrates 300, an example of the screen displayed after when 1825 is tapped. This indicates that the user wants to directly fill in the variable input array 3012. FIG. 30 also illustrates that the user has entered or selected “force” as the extent of the first variable and “distance” as the extent of the second variable via virtual keyboard 3060. After two variable/constants have had input entered, the EE generates another variable/constant input row for each new variable/constant so that more variable/constants a can be input. Thus, a third row appears after the first two have had data input into them. UILabel 3014 suggests that the user “select an equation or enter more information above”.

FIG. 31 illustrates 310, an example of screen 300 displayed after “m” is entered via virtual keyboard 3160 into the symbol UITextField of the third variable/constant row. This extra constraint reduces the matching equations in UIScrollView to two. A fourth variable/constant row is generated in generated in variable input array 3112. If an equation is selected, a screen like 220 is displayed with the information displayed appropriate to that equation.

FIG. 32 illustrates 320, an example of the screen displayed after the user has selected one of the many ways to equate two states of an equation. For example, the user can tap button 1827, button 1940, entering the name of a two-state equation (such as “the Combined Gas Law”); entering a two-state equation; or tapping a “2 states” button (e.g. 2232). Some equations are inherently two-state equations, like the Combined Gas Law, but many other equations can be made into two-state equations. The EE makes available two-state versions of all relevant otherwise non-two-state equations. If an equation contains a constant, the EE displays it as solved for the constant and sets the two states equal, eliminating the constant. For example, Coulomb's Law is written as

$$F = \frac{{k}_{e} \cdot {q}_{1} \cdot {q}_{2}}{{r}^{2}} ,$$

where kₑ is a constant, solved for the constant

$${k}_{e} = \frac{F \cdot {r}^{2}}{{q}_{1} \cdot {q}_{2}}$$

so EE makes it available as the two-state equation:

$$\frac{{F}_{i} \cdot {r}_{i}^{2}}{{q}_{1 i} \cdot {q}_{2 i}} = \frac{{F}_{f} \cdot {r}_{f}^{2}}{{q}_{1 f} \cdot {q}_{2 f}}$$

or its inverse:

$$\frac{{q}_{1 i} \cdot {q}_{2 i}}{{F}_{i} \cdot {r}_{i}^{2}} = \frac{{q}_{1 f} \cdot {q}_{2 f}}{{F}_{f} \cdot {r}_{f}^{2}}$$

Note that “i” and “f” are used instead of “1” and “2” for subscripts because “1” and “2” are already used to designate charge 1 and charge 2.

Where there are no constants in the equation, the EE stores or produces an equator (detailed elsewhere herein). For example, the equator for

$$F = E \cdot q is \frac{E \cdot q =}{F} .$$

A two-state version of this equation is:

$$\frac{{E}_{1} \cdot {q}_{1}}{{F}_{1}} = \frac{{E}_{2} \cdot {q}_{2}}{{F}_{2}}$$

or its inverse:

$$\frac{{F}_{1}}{{E}_{1} \cdot {q}_{1}} = \frac{{F}_{2}}{{E}_{2} \cdot {q}_{2}}$$

Selecting one of these equations is very similar to selecting a one-state equation. The user can enter the name an equation in editable UITextField 3223 using virtual keyboard 3260. The user can enter the topic of a subset of equation in editable UITextField 3224. The user can enter an equation in editable UITextField 3222. The user can enter extents, symbols, values and units for both states in editable UITextField variable/constant input array 3225. UIScrollView 3227 displays a single formatted equation when an equation name or equation is entered. UIScrollView 3227 displays multiple formatted equations when the EE doesn't have enough information to reduce the number of eligible equations to one.

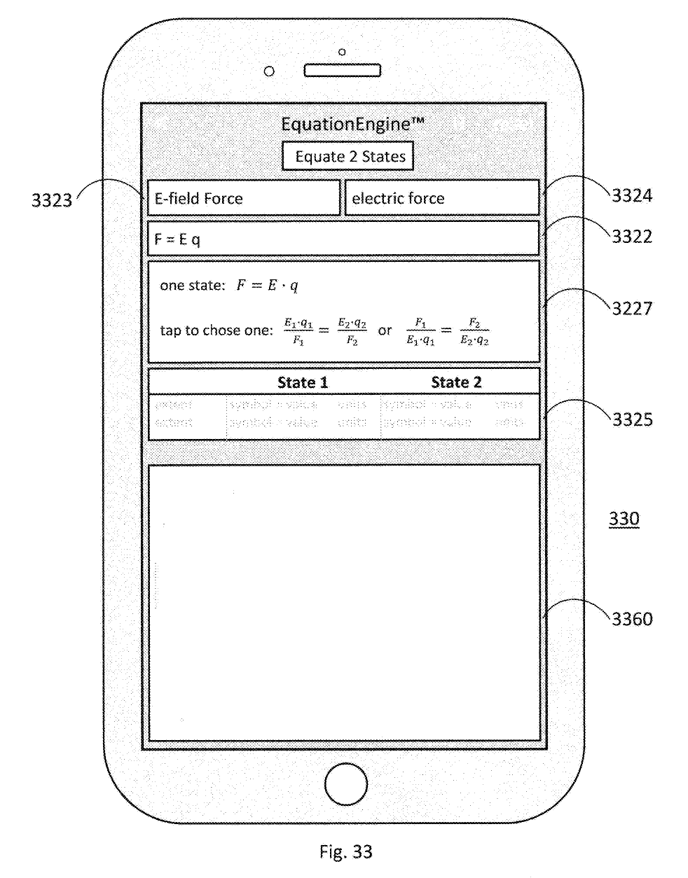

FIG. 33 illustrates 330, an example of screen 320 displayed after the user has entered “F=Eq” in the equation input UITextField 3322 or “E-field force” in the equation name UITextField 3323. The equation topic UITextField has been filled-in and 3227 displays the formatted one-state equation. The user is instructed to “tap to chose one:” and of the two-state equations displayed for this one-state equation. Until that choice is made, the order of the variables is not known and 3325 cannot be further filled in. The virtual keyboard is 3360.

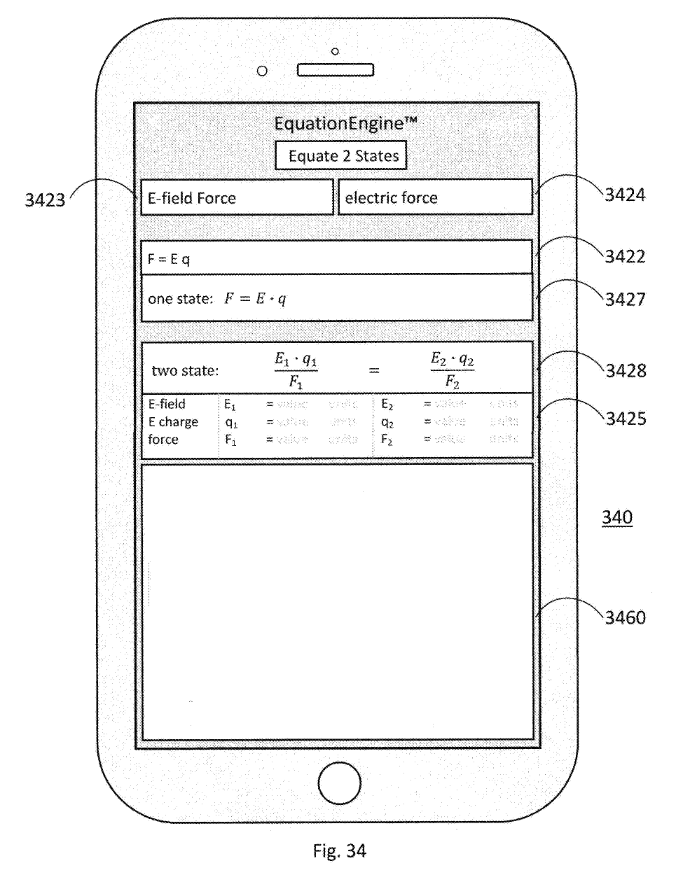

FIG. 34 illustrates 340, an example of screen 330 displayed after the user has tapped the first of the two-state equations displayed in 3227. The selected two-state equation replaces “State 1” and “State 2” in UILabel 3428. A third input variable row has been added to 3425 to support the three variables in the one-state equation. The extents and their symbols are displayed in 3425. Now the EE is awaiting the user's entry of the values and units of the variables via virtual keyboard 3460.

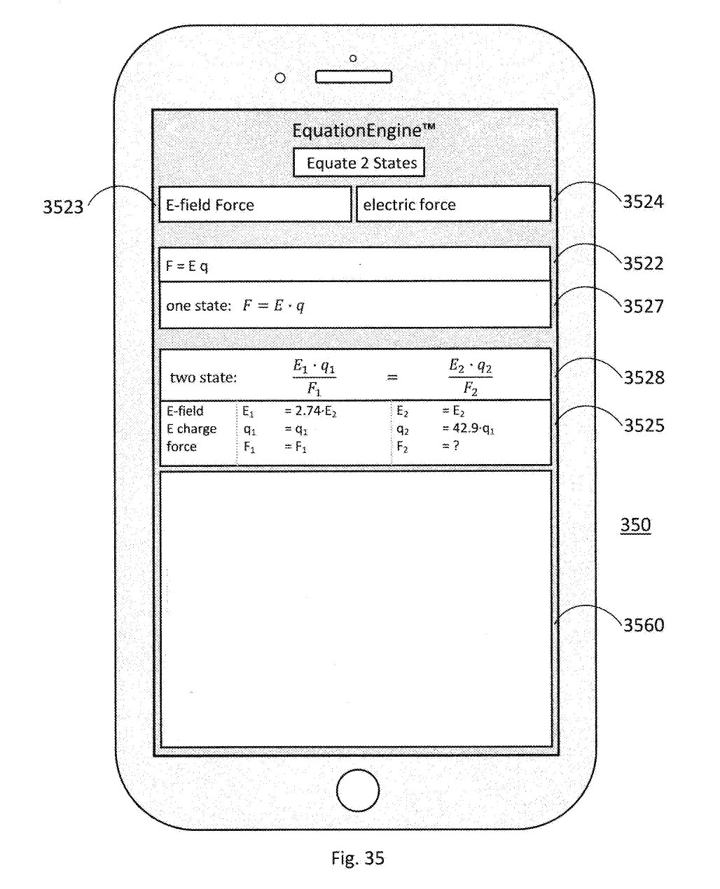

FIG. 35 illustrates 350, an example of screen 340 displayed after the user has entered all of the values needed in 3525, but before the EE has dismissed virtual keyboard 3560 and computed and displayed the solution. Rather than an absolute value for “E₁”, the user enters the relative value “2.74·E₂”. When relative values are used, the referred to variable is entered for the value of that variable, i.e. “E₂=E₂”. Likewise, “q₂=42.9·q₁”. Similarly, because “F₂” is the unknown and “F₁=F₁”, the equation is solved in terms of “F₁”.

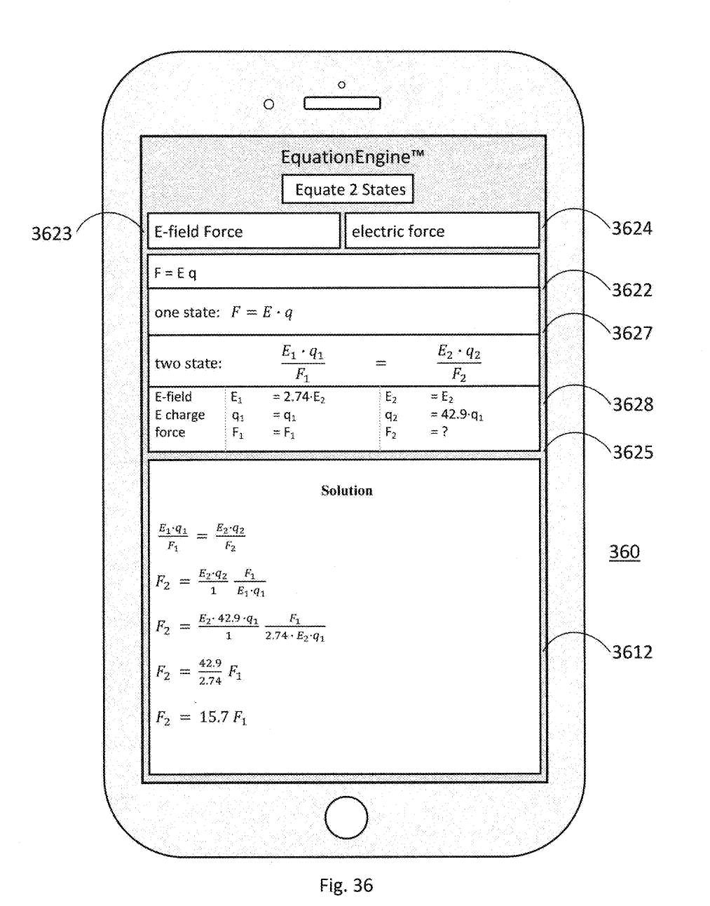

FIG. 36 illustrates 360, an example of screen 350 displayed after the user has entered all of the values needed in 3525 and after the EE has computed and displayed the solution in 3612.

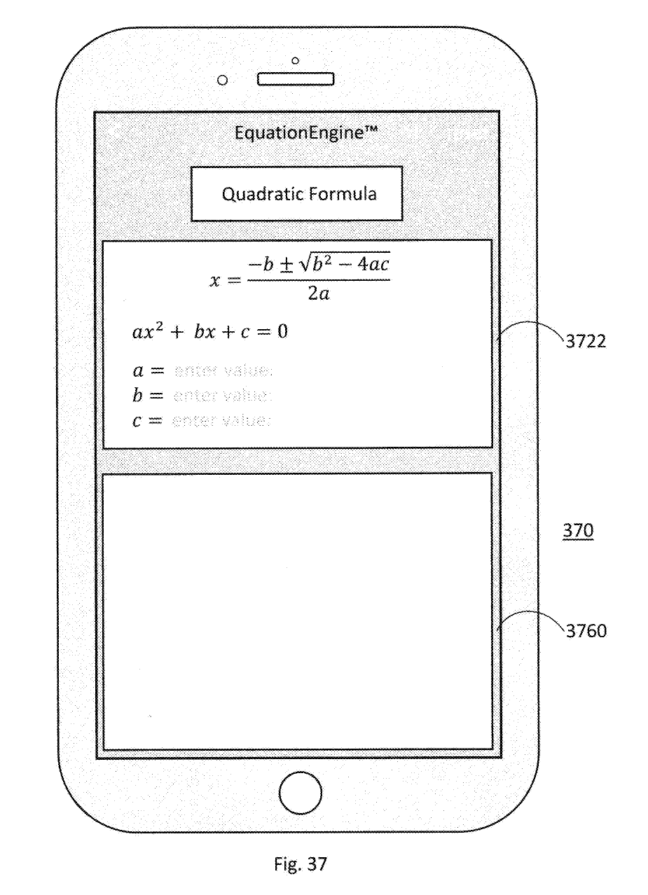

FIG. 37 illustrates 370, an example of the screen displayed after the user has tapped button 1830. UILabel 3722 displays the quadratic formula, the equation that the quadratic formula solves, the symbols for the coefficients “a=”, “b=”, and “c=” and a UITextField next to the right of each coefficient's “=” with the placeholder “enter value:”. When 370 is displayed, the cursor is automatically placed in the UITextField for “a=”. After the user enters the value in the “a=” UITextField and enters “return” via virtual keyboard 3760, the cursor automatically is place in the “b=” UITextField. After the user enters the value in the “b=” UITextField and enters “return”, the cursor automatically is place in the “c=” UITextField. After the user enters the value in the “c=” UITextField and enters “return”, the EE solves the quadratic formula.

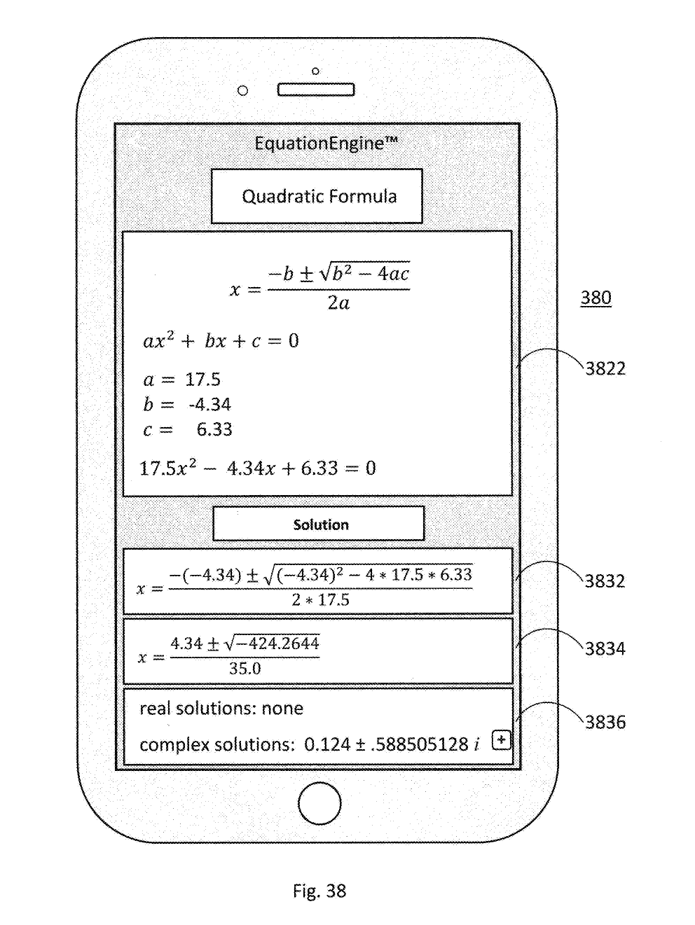

FIG. 38 illustrates 380, an example of the screen displayed after the user has entered the values for “a”, “b”, and “c”, i.e. after the user has entered the value for “c” and entered “return”. UILabel 3822 displays the equation the values of “a”, “b”, and “c” still in their respective editable UITextFields (so they can still be edited at this stage). UILabel 3822 also displays the values of “a”, “b”, and “c” substituted in the general quadratic equation. UILabel 3832 illustrates the quadratic formula with the values entered by the user substituted for “a”, “b”, and “c”. UILabel 3834 illustrates the quadratic formula with the first level of simplification and the exact value if the solutions. UILabel 3836 illustrates the solutions in decimal form.

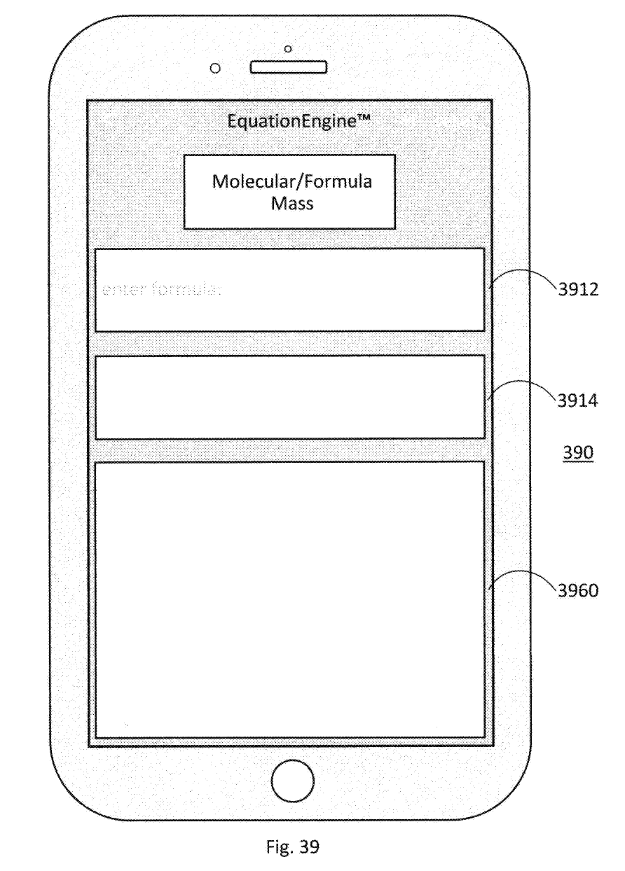

FIG. 39 illustrates 390, an example of the screen displayed after the user has tapped button 1850. The user employs virtual keyboard 3960 to enter the formula of an element, compound, ion, or other chemical species into editable UITextField 3912. The formatted formula is displayed in UILabel 3914. If the entered formula in 3912 and/or the formatted formula in 3914 become too large, the font size in that field is reduced so that it can fit.

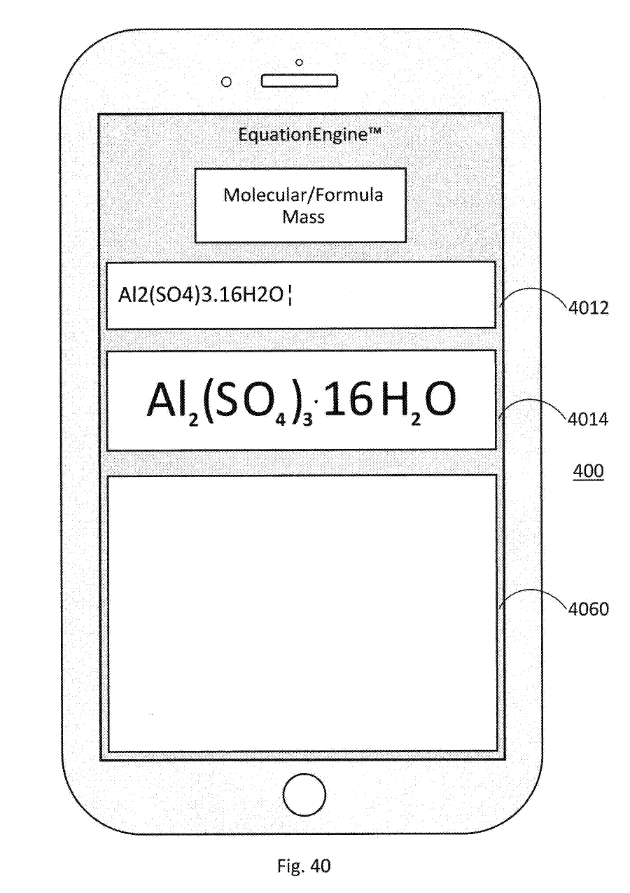

FIG. 40 illustrates 400, an example of the screen displayed after the user has entered the formula using virtual keyboard 4060, but before he has entered “return” and while in 4012. The cursor is shown at the end of the entered formula. UILabel 4014 illustrates the displayed formatted formula.

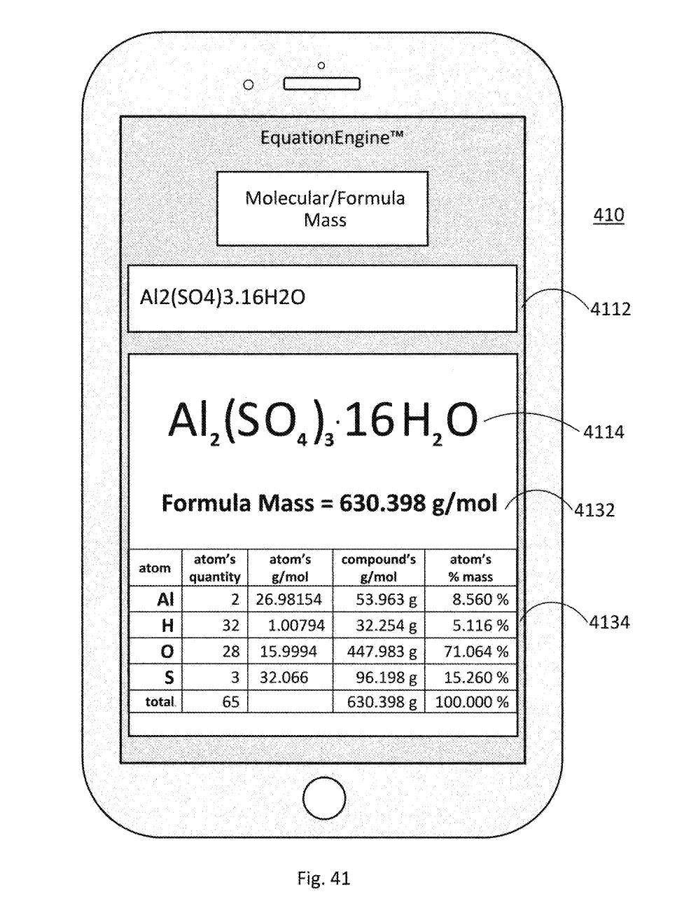

FIG. 41 illustrates 410, an example of the screen displayed after the user has entered the formula using virtual keyboard 4060 and just after he has entered “return” while in 4012. Formatted formula 4112 is displayed in a field with 4132, the formula mass to the appropriate significant figures. The EE determines that this is an ionic compound, and thus the appropriate description is “formula mass”. Below the formula mass is displayed an array of UILabels (or a UITableView) displaying each constituent atom, the number of each of those atoms in the chemical species, the molar mass of each of those atoms, the total mass of the atoms of each species in the compound, and the percent mass of each atom. These values are useful in common stoichiometric problems. Any of the values can be tapped to create the pop-up described elsewhere herein that permits the user to save its value and units as a named constant.

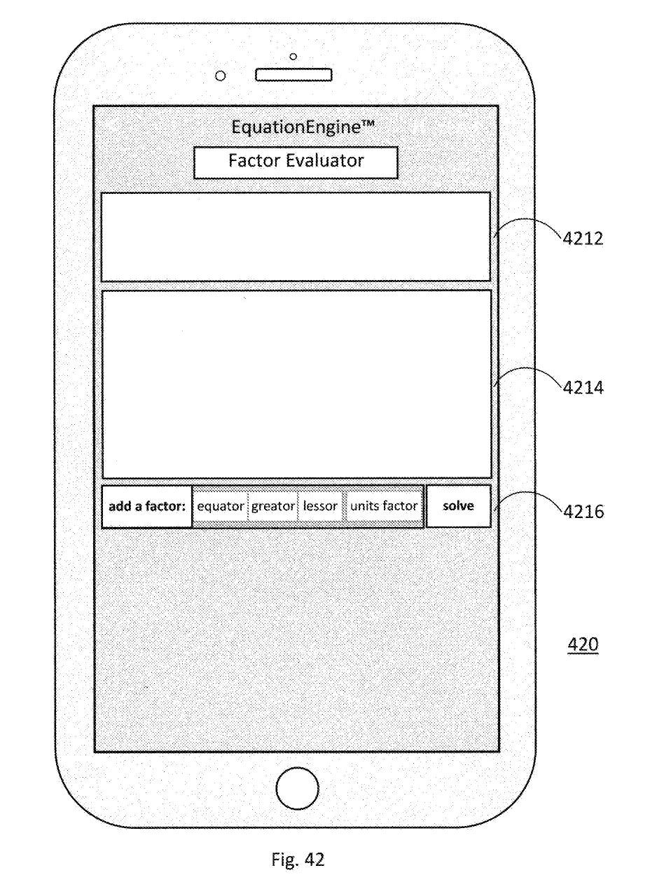

FIG. 42 illustrates screen 420 which is invoked when button 1828 is tapped. UITextView 4212 displays selected factors. Value and units data for each variable in a factor will be displayed in 4214. To add a factor, the user taps the “equator” button, the “greator” button, the “lessor” or the “units factor” button in 4216. To solve for the factors selected, the user taps the “solve” button in 4216.

FIG. 43 illustrates screen 430. When the user taps any button in 4216, except “units factor”, screen 190 is displayed, permitting the user to select an equation using many methods. When the equation is selected, the EE converts it to an equator and displays said equator in 4312 and a number below the equator, in this case a “1”. The same number followed by a “:” is displayed in 4314. Then in 4414, the list of symbols in the equator is displayed. Next to each symbol is an “=” followed by a field for the value of the variable represented by the symbol and a field for said variable's units. The standard units for the variable are added. The user can tap any variable units field and enter or select other units to be used. Screen 430 represents the state of the screen before the user has entered values or altered units using virtual keyboard 4360. When a factor is added, the symbols for its variable are subscripted by the number below it unless it is designated as the unknown or if the symbol is already subscripted (e.g. Fₑ). If the user taps “units factor”, no equation or equator needs to be selected. The next number label (for example “4” is displayed below the ratio “numerator₄/denominator₄”. A line is generated in 4314 for the user to enter the values and units for “numerator₄” and “denominator₄”. Note that it is not necessary for the values of some variables to have units.

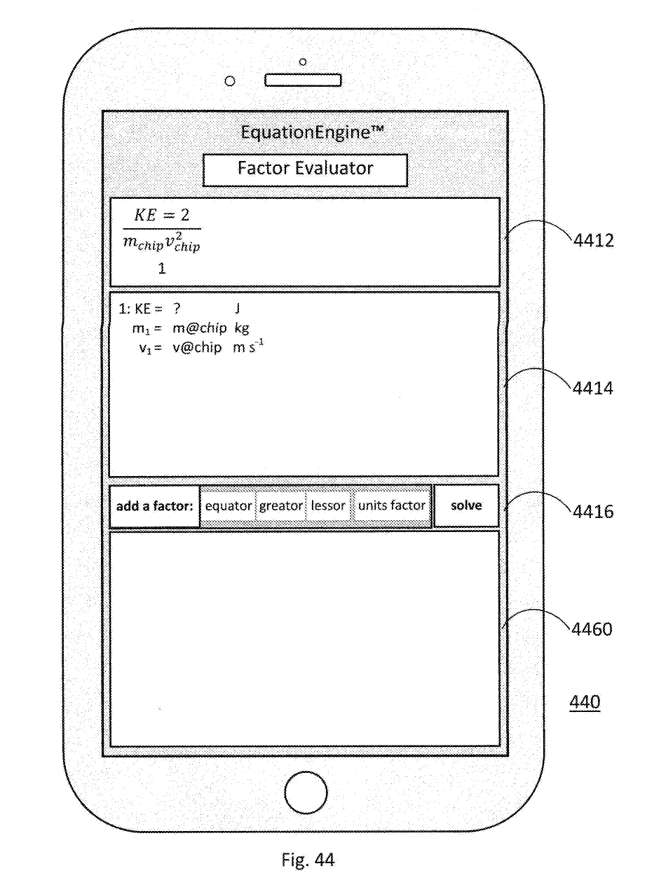

FIG. 44 illustrates screen 440. This represents the state of the screen after the user has entered “?” for the value of “KE”, “m@chip” for the value of m₁ and “v@chip” for the value of v₁ in 4415. Because the KE is designated as, the unknown, its symbol is unchanged. But m₁ and v₁ are replaced with m_{chip} and v_{chip} respectively in 4412. The “@” designates that the immediately following text is a subscript.

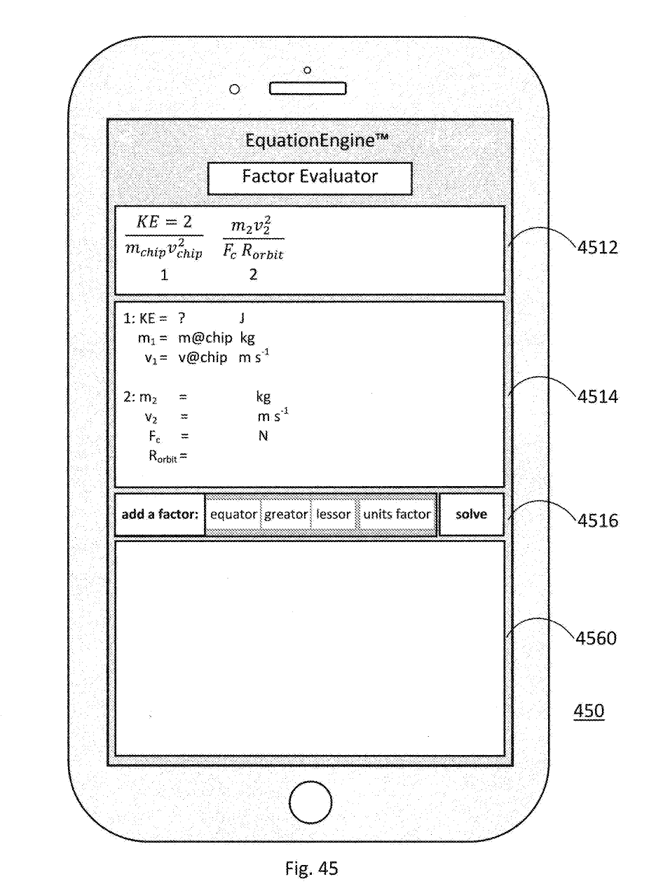

FIG. 45 illustrates screen 450. This represents the state of the screen after the user has tapped “equator” again and selected a second equator. Again, the EE has entered the selected equator with a “2” below it in 4512 and the label “2:” followed by the symbols in the second equator, subscripted by “2”, except of “F_{c}” and “R_{orbit}”.

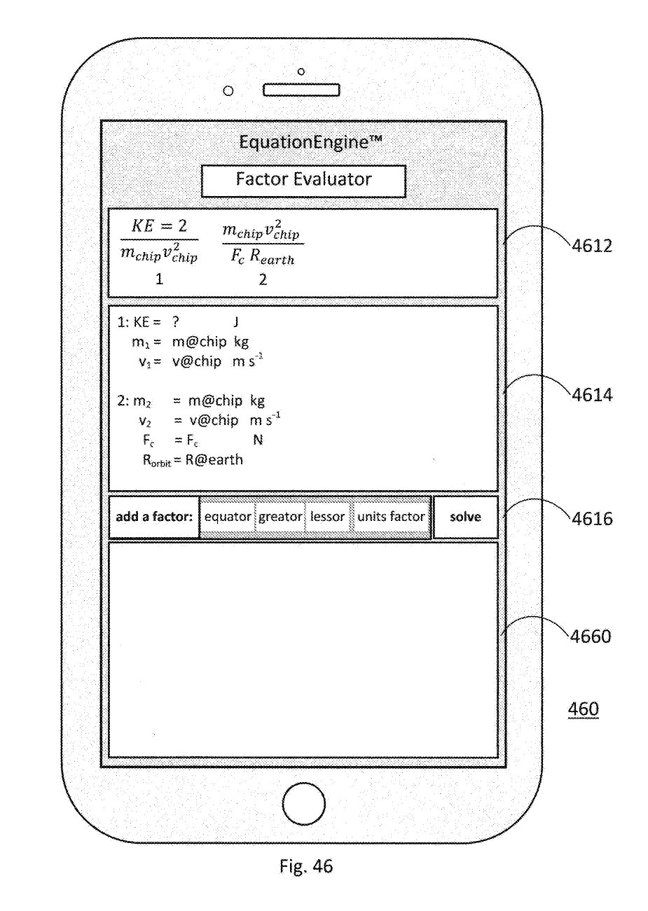

FIG. 46 illustrates screen 460. This represents the state of the screen after the user has entered the values for the second equation's variables. “hearth” or “R@earth” is recognized as the constant representing the radius of the earth. In this example, the values for the variables are filled in after each equator is selected and before the next. This is unnecessary. Those values can be entered at any time prior to the EE solving the system of factors.

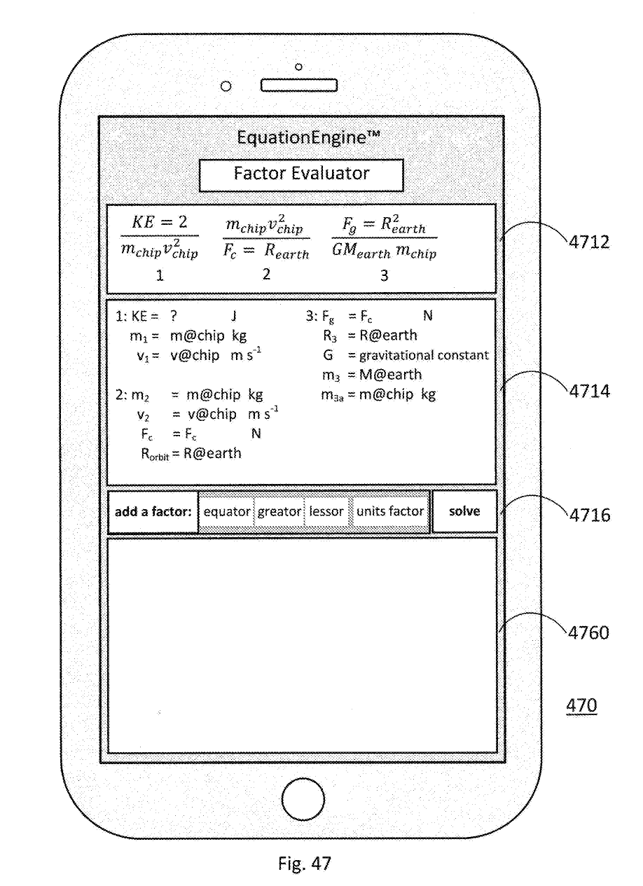

FIG. 47 illustrates screen 470. This represents the state of the screen after the user has tapped “equator” a third time and selected a third equator. The user has entered all of the values he chooses to.

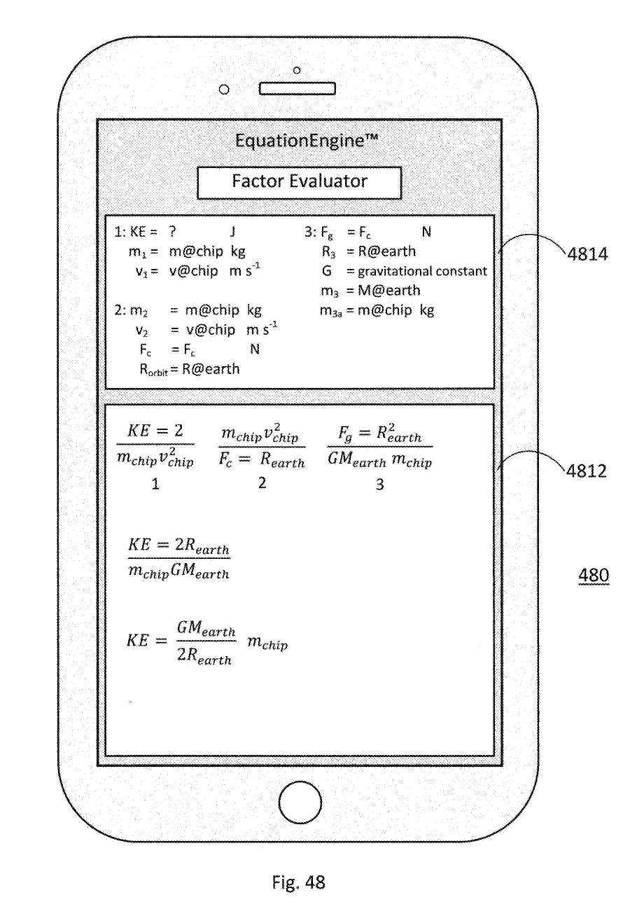

FIG. 48 illustrates screen 480. This represents the state of the screen after the “solve” button in 4716 was tapped. Views 4812 and 4814 are moved. The first line in 4812 is the same as the contents of 4712. The second line in 4812 illustrates the equator solution of the first line in 4812. The third line in 4812 illustrates said equator solution translated to an equation. In this case, the user had chosen not to enter any numerical values. Had numerical values been entered, they would have been evaluated as illustrated elsewhere herein.

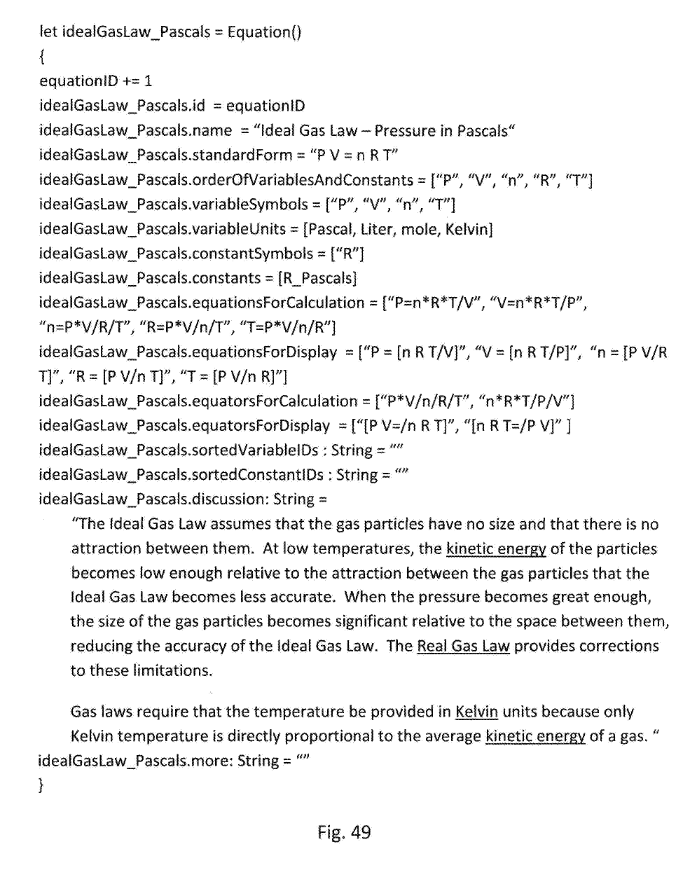

FIG. 49 illustrates an example of Apple Swift code that stores information needed for a given equation, in this case the Ideal Gas Law where pressure is in Pascals. This can be a Class or Struct. Each equation has a unique integer .equationID used to identify that equation in a list of IDs. The name is used in searches of equations by name. The .standardForm is a string that can be used to display the equation as it is generally known. The .variableSymbols and .variableUnits arrays are in the same order so that there is a one-to-one mapping between the .variableSymbols and their units (and, hence their extents). The same relationship exists between the lists of constants and their symbols. The same relationship exists between the .orderOfVariablesAndConstants and the .equationsForCalculation and .equationsForDisplay. Thus, once the equation is determined, if the user selects “n” (the third in the list) as the unknown, the EE knows to use the third of the .equationsForCalculation and the third of the .equationsForDisplay. There are two .equatorsForDisplay and .equatorsForCalculation, one the multiplicative inverse of the order. These two lists are in the same order so that when the user chooses one of the displayed equators, the EE knows which one to calculate with. The .sortedVariableIDs and .sortedConstantIDs are constructed at compile time and each constitutes a list of integers. Each integer is a unique identifier for each variable's extent (or units when there is ambiguity) and constant, respectively. The EE builds a .sortedVariableIDs and .sortedConstantIDs from the user's input of extents, units, and/or symbols and compared to the .sortedVariableIDs and .sortedConstantIDs equations to determine which equation the user wants. If the user's list is incomplete, there might be many matches, all of which can be displayed and the user can directly chose between them. The .discussion provides the user a brief discussion regarding equation when requested. The underscores in the discussion indicate that these terms provide hyperlinks to more information on them. The .more string provides links to more information detailed elsewhere herein.

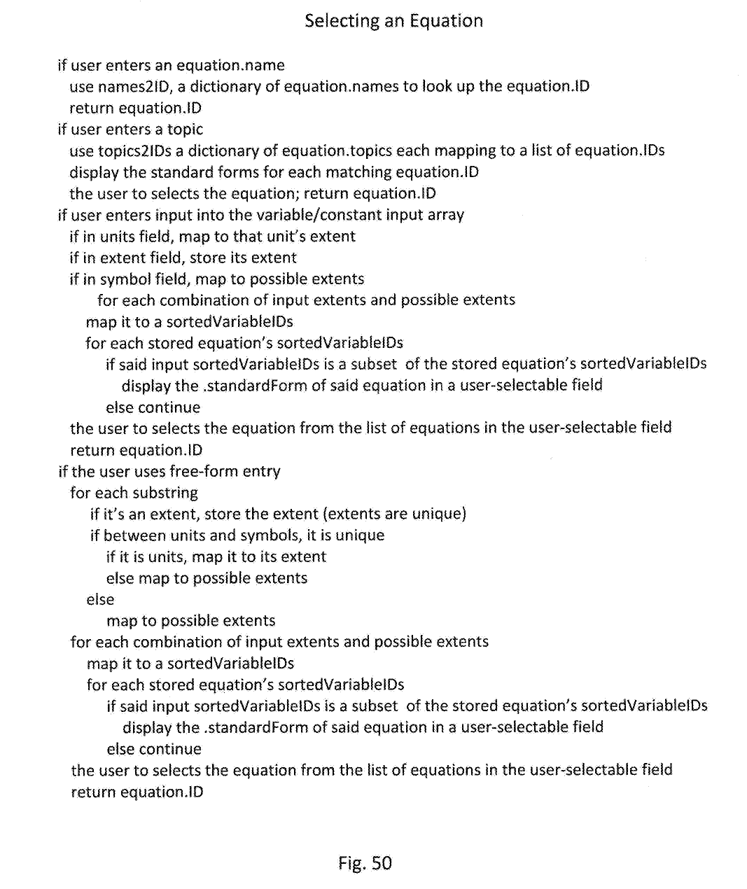

FIG. 50 lists pseudo-code for selecting an equation using the EE.

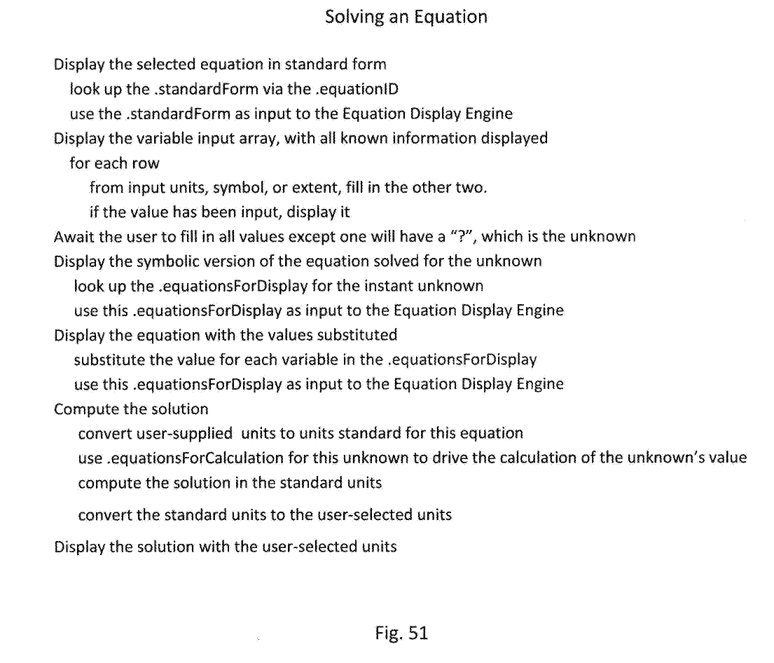

FIG. 51 lists pseudo-code for solving an equation using the EE.

What is claimed is:

1. A computer-implemented method for a real or virtual user to select and manipulate equations comprising: selecting a symbolic equation; reducing the number of unknowns in said equation to one; collecting a value for each variable in the equation, except for said unknown; and displaying the solution.

2. The method as claimed in claim 1 wherein said symbolic equation as solved for said unknown variable is displayed.

3. The method as claimed in claim 1 wherein said symbolic equation for said unknown variable is displayed where said collected values are substituted for said values of variables.

4. The method as claimed in claim 1 wherein said symbolic equation for said unknown variable is displayed where said collected values are substituted for said values of variables are at least partially combined.

5. A computer-implemented method for a real or virtual user employing equators comprising: displaying equators.

6. The method as claimed in claim 5 wherein said method comprises converting equations to equators.

7. The method as claimed in claim 5 wherein said method comprises simplifying equations by multiplying equators and simplifying, the result.
